(19) United States
(12) Patent Application Publication
(10) Pub. No.: US 2026/0260185 A1
(43) Pub. Date: Sep. 3, 2026

(54) SYSTEMS AND METHODS FOR PROVIDING CONTEXT-AWARE ASSISTANCE IN CONTACT CENTER PLATFORM

(71) Applicant: GENESYS CLOUD SERVICES, INC., MENLO PARK, CA (US)

(72) Inventors: MACIEJ DABROWSKI, GALWAY (IE); JOHN PETTENGILLL, MENLO PARK, CA (US); CHRISTOPHER FISCHER, MENLO PARK, CA (US); COLM JOHN HALLY, GALWAY (IE); JOHN PATRICK SEXTON, GALWAY (IE); SEAMUS HAYES, GALWAY (IE); YUSUF CINAR, GALWAY (IE); ADRIAN RYAN, GALWAY (IE); EDEL KELLY, GALWAY (IE)

(73) Assignee: GENESYS CLOUD SERVICES, INC., MENLO PARK, CA (US)

(21) Appl. No.: 19/552,519

(22) Filed: Feb. 27, 2026

Related U.S. Application Data
(60) Provisional application No. 63/764,910, filed on Feb. 28, 2025.
(60) Provisional application No. 63/877,647, filed on Sep. 8, 2025.

(51) Int. Cl. G06Q 10/0631; G06F 3/0484

(52) U.S. Cl. CPC G06Q 10/063112; G06F 3/0484

(57) ABSTRACT

Systems and methods for providing context-aware assistance in a contact center platform are provided. In particular, a computing system may determine user context data associated with a user of a contact center, the user context data including a current application context and receive a user input from the user on an interface view indicative of a requested operation, the requested operation including at least one of: retrieving information, managing one or more users, or managing work items. The computing system may further determine operational context data, the operational context data being contextually relevant information associated with the requested operation based on a role of the user and the current application context, determine if the user is authorized to perform the requested operation based on the role of the user, and in response to the determination that the user is authorized, perform the requested operation based on the operational context data without navigating away from the interface view.

### CROSS-REFERENCE TO RELATED APPLICATIONS

This application claims priority to U.S. Provisional Application No. 63/877,647, titled SYSTEMS AND METHODS FOR PROVIDING CONTEXT-AWARE ASSISTANCE IN CONTACT CENTER PLATFORM, filed Sep. 8, 2025, and U.S. Provisional Application No. 63/764,910, titled SYSTEMS AND METHODS FOR DYNAMICALLY CREATING CASES, filed Feb. 28, 2025, each of which is hereby incorporated by reference in its entirety.

### BACKGROUND

Contact centers serve as essential infrastructure for organizations to manage customer interactions across multiple communication channels, including voice calls, text messaging, web chat, email, and social media. Supervisors within such contact centers are typically responsible for overseeing agent performance, maintaining service quality, and supporting overall customer satisfaction objectives. To fulfill these duties, supervisors may perform various administrative and operational tasks, such as creating and managing agent profiles, updating agent skill assignments, configuring routing behaviors, and assigning agents to one or more communication queues based on workload distribution or business requirements. These supervisory tasks are often manual, repetitive, and labor-intensive, particularly as the scale and complexity of contact center operations increase.

Conventional contact center platforms may require supervisors to navigate across multiple screens, menus, or separate applications to complete routine tasks, resulting in context-switching that reduces efficiency and increases the likelihood of errors. Additionally, supervisors may lack real-time visibility into relevant contextual information needed to make informed decisions, such as current queue status, agent availability, or historical performance data. There is therefore a need for improved systems and methods that enable supervisors to perform administrative and operational tasks more efficiently while maintaining awareness of the current operational context.

It is with respect to these and other general considerations that embodiments have been described. Also, although relatively specific problems have been discussed, it should be understood that the embodiments should not be limited to solving the specific problems identified in the background.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a method for providing context-aware assistance in a contact center platform is provided. The method includes determining user context data associated with a user of a contact center, the user context data including a current application context. The method further includes receiving a user input from the user on an interface view indicative of a requested operation, the requested operation including at least one of: retrieving information, managing one or more users, or managing work items. The method also includes determining operational context data, the operational context data being contextually relevant information associated with the requested operation based on a role of the user and the current application context. The method additionally includes determining if the user is authorized to perform the requested operation based on the role of the user. The method further includes, in response to determining that the user is authorized, performing the requested operation based on the operational context data without navigating away from the interface view.

According to another aspect of the present disclosure, a system for providing context-aware assistance in a contact center platform is provided. The system includes a processor and a memory storing instructions that, when executed by the processor, cause the system to determine user context data associated with a user of a contact center, the user context data including a current application context. The instructions further cause the system to receive a user input from the user on an interface view indicative of a requested operation, the requested operation including at least one of: retrieving information, managing one or more users, or managing work items. The instructions also cause the system to determine operational context data, the operational context data being contextually relevant information associated with the requested operation based on a role of the user and the current application context. The instructions additionally cause the system to determine if the user is authorized to perform the requested operation based on the role of the user. The instructions further cause the system to, in response to the determination that the user is authorized, perform the requested operation based on the operational context data without navigating away from the interface view.

According to yet another aspect of the present disclosure, a non-transitory computer-readable medium storing instructions that, when executed by a processor, cause the processor to perform operations is provided. The operations include determining user context data associated with a user of a contact center, the user context data including a current application context. The operations further include receiving a user input from the user on an interface view indicative of a requested operation, the requested operation including at least one of: retrieving information, managing one or more users, or managing work items. The operations also include determining operational context data, the operational context data being contextually relevant information associated with the requested operation based on a role of the user and the current application context. The operations additionally include determining if the user is authorized to perform the requested operation based on the role of the user. The operations further include, in response to determining that the user is authorized, performing the requested operation based on the operational context data without navigating away from the interface view.

The foregoing general description of the illustrative embodiments and the following detailed description thereof are merely exemplary aspects of the teachings of this disclosure and are not restrictive.

### BRIEF DESCRIPTION OF THE DRAWINGS

A more complete appreciation of the present invention will become more readily apparent as the invention becomes better understood by reference to the following detailed description when considered in conjunction with the accompanying drawings, in which like reference symbols indicate like components, wherein:

FIG. 1 depicts a schematic block diagram of a computing device in accordance with exemplary embodiments of the present invention and/or with which exemplary embodiments of the present invention may be enabled or practiced;

FIG. 2 depicts a schematic block diagram of a communications infrastructure or contact center in accordance with exemplary embodiments of the present invention and/or with which exemplary embodiments of the present invention may be enabled or practiced;

FIG. 3 illustrates an exemplary user interface rendered on a computing device, depicting activities across multiple queues within a contact center platform that includes a context-aware assistant, in accordance with an embodiment of the present disclosure;

FIGS. 4A-4K illustrate exemplary user interfaces of the context-aware assistant, depicting the process of adding a new user on the contact center platform, in accordance with an embodiment of the present disclosure;

FIGS. 5A-5F illustrate exemplary user interfaces of the context-aware assistant, depicting the process of assigning skills to users on the contact center platform, in accordance with an embodiment of the present disclosure;

FIGS. 6A-6D illustrate exemplary user interfaces of the context-aware assistant, depicting the process of assigning users on the contact center platform, in accordance with an embodiment of the present disclosure;

FIG. 7 illustrates a graphical user interface showing a task delivered to a transport coordinator agent for assigning a driver, in accordance with an embodiment of the present disclosure;

FIG. 8 illustrates a graphical user interface showing editing of custom attributes for a workitem, in accordance with an embodiment of the present disclosure;

FIG. 9 illustrates a graphical user interface showing selection and assignment of a driver, in accordance with an embodiment of the present disclosure;

FIG. 10 illustrates a graphical user interface showing a Cases tool panel with a Collaborate tab for group chat, in accordance with an embodiment of the present disclosure;

FIGS. 11A and 11B illustrate a graphical user interface showing notification of group chat members about driver assignment, in accordance with an embodiment of the present disclosure;

FIG. 12 illustrates a graphical user interface showing details of an assigned case, in accordance with an embodiment of the present disclosure;

FIG. 13 illustrates a graphical user interface showing stages of tasks within a case, in accordance with an embodiment of the present disclosure;

FIG. 14 illustrates a graphical user interface showing a Workitem Status tool for updating task status, in accordance with an embodiment of the present disclosure; and

FIGS. 15A and 15B illustrate a graphical user interface showing a Workitem Status tool for updating task status, in accordance with an embodiment of the present disclosure.

### DETAILED DESCRIPTION

For the purpose of promoting an understanding of the principles of the invention, reference will now be made to the exemplary embodiments illustrated in the drawings and specific language will be used to describe the same. It will be apparent, however, to one having ordinary skill in the art that the detailed material provided in the examples may not be needed to practice the present invention. In other instances, well-known materials or methods have not been described in detail in order to avoid obscuring the present invention. Additionally, further modification in the provided examples or application of the principles of the invention, as presented herein, are contemplated as would normally occur to those skilled in the art. Particular features, structures or characteristics may be combined in any suitable combinations and/or sub-combinations in one or more embodiments or examples. Those skilled in the art will recognize that various embodiments may be computer implemented using many different types of data processing equipment, with embodiments being implemented as an apparatus, method, or computer program product. Example embodiments, thus, may take the form of a hardware embodiment, a software embodiment, or combination thereof.

### Computing Device

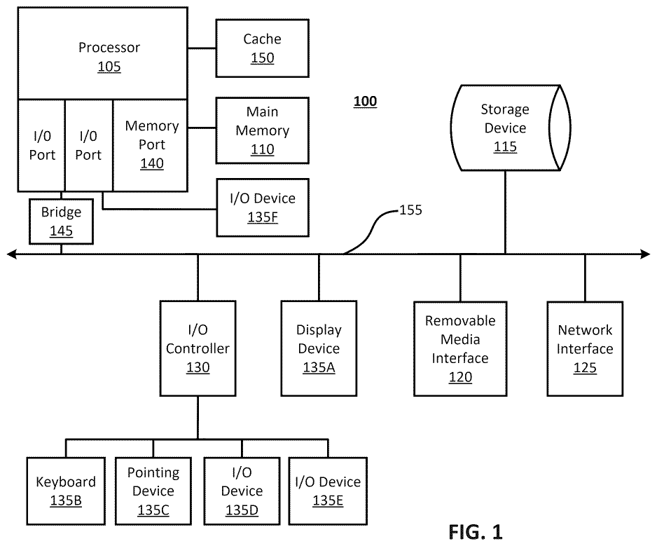

The present invention may be computer implemented using different forms of data processing equipment, for example, digital microprocessors and associated memory, executing appropriate software programs. By way of background, FIG. 1 illustrates a schematic block diagram of an exemplary computing device 100 in accordance with embodiments of the present invention and/or with which those embodiments may be enabled or practiced.

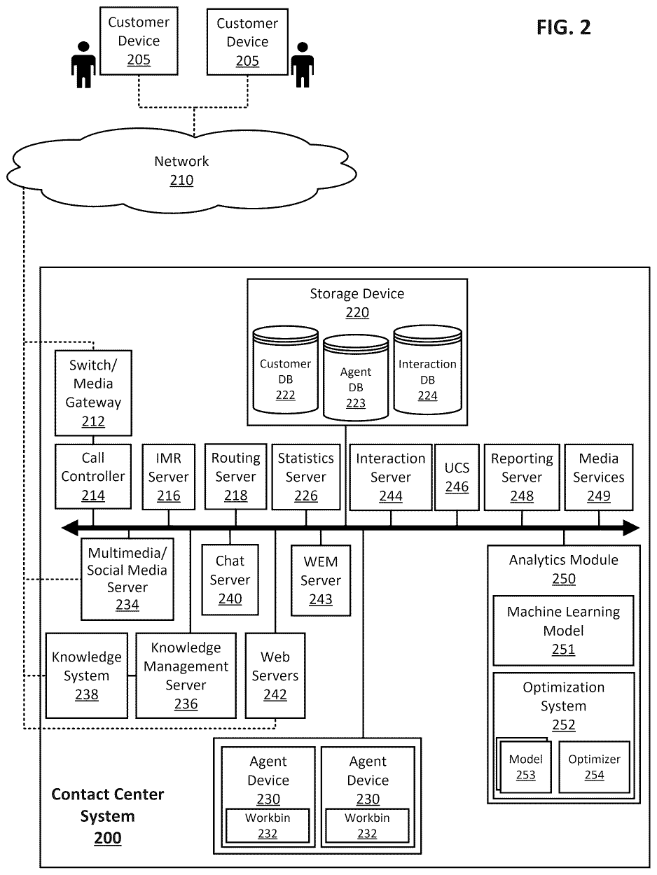

The computing device 100, for example, may be implemented via firmware (e.g., an application-specific integrated circuit), hardware, or a combination of software, firmware, and hardware. Each of the servers, controllers, switches, gateways, engines, and/or modules in the following figures (which collectively may be referred to as servers or modules) may be implemented via one or more of the computing devices 100. As an example, the various servers may be a process running on one or more processors of one or more computing devices 100, which may be executing computer program instructions and interacting with other systems or modules in order to perform the various functionalities described herein. Unless otherwise specifically limited, the functionality described in relation to a plurality of computing devices may be integrated into a single computing device, or the various functionalities described in relation to a single computing device may be distributed across several computing devices. Further, in relation to the computing systems described in the following figures—such as, for example, the contact center 200 of FIG. 2—the various servers and computer devices thereof may be located on local computing devices 100 (i.e., on-site or at the same physical location as contact center agents), remote computing devices 100 (i.e., off-site or in a cloud computing environment, for example, in a remote data center connected to the contact center via a network), or some combination thereof. Functionality provided by servers located on off-site computing devices may be accessed and provided over a virtual private network (VPN), as if such servers were on-site, or the functionality may be provided using a software as a service (SaaS) accessed over the Internet using various protocols, such as by exchanging data via extensible markup language (XML), JSON, and the like.

As shown in the illustrated example, the computing device 100 may include a central processing unit (CPU) or processor 105 and a main memory 110. The computing device 100 may also include a storage device 115, removable media interface 120, network interface 125, I/O controller 130, and one or more input/output (I/O) devices 135, which as depicted may include an, display device 135A, keyboard 135B, and pointing device 135C. The computing device 100 further may include additional elements, such as a memory port 140, a bridge 145, I/O ports, one or more additional input/output devices 135D, 135E, 135F, and a cache memory 150 in communication with the processor 105.

The processor 105 may be any logic circuitry that responds to and processes instructions fetched from the main memory 110. For example, the processor 105 may be implemented by an integrated circuit, e.g., a microprocessor, microcontroller, or graphics processing unit, or in a field-programmable gate array or application-specific integrated circuit. As depicted, the processor 105 may communicate directly with the cache memory 150 via a secondary bus or backside bus. The main memory 110 may be one or more memory chips capable of storing data and allowing stored data to be accessed by the central processing unit 105. The storage device 115 may provide storage for an operating system, which controls scheduling tasks and access to system resources, and other software. Unless otherwise limited, the computing device 100 may include an operating system and software capable of performing the functionality described herein.

As depicted in the illustrated example, the computing device 100 may include a wide variety of I/O devices 135, one or more of which may be connected via the I/O controller 130. Input devices, for example, may include a keyboard 135B and a pointing device 135C, e.g., a mouse or optical pen. Output devices, for example, may include video display devices, speakers, and printers. More generally, the I/O devices 135 may include any conventional devices for performing the functionality described herein.

Unless otherwise limited, the computing device 100 may be any workstation, desktop computer, laptop or notebook computer, server machine, virtualized machine, mobile or smart phone, portable telecommunication device, media playing device, or any other type of computing, telecommunications or media device, without limitation, capable of performing the operations and functionality described herein. The computing device 100 may include a plurality of such devices connected by a network or connected to other systems and resources via a network. Unless otherwise limited, the computing device 100 may communicate with other computing devices 100 via any type of network using any conventional communication protocol.

### Contact Center

With reference now to FIG. 2, a communications infrastructure or contact center system (or simply “contact center”) 200 is shown in accordance with exemplary embodiments of the present invention and/or with which exemplary embodiments of the present invention may be enabled or practiced. By way of background, customer service providers generally offer many types of services through contact centers. Such contact centers may be staffed with employees or customer service agents (or simply “agents”), with the agents serving as an interface between a company, enterprise, government agency, or organization (hereinafter referred to interchangeably as an “organization” or “enterprise”) and persons, such as users, individuals, or customers (hereinafter referred to interchangeably as “individuals” or “customers”). For example, the agents at a contact center may assist customers in making purchasing decisions, receiving orders, or solving problems with products or services already received. Within a contact center, such interactions between agents and customers may be conducted over a variety of communication channels, such as, for example, via voice (e.g., telephone calls or voice over IP or VoIP calls), video (e.g., video conferencing), text (e.g., emails and text chat), screen sharing, co-browsing, or the like.

Operationally, contact centers generally strive to provide quality services to customers while minimizing costs. For example, one way for a contact center to operate is to handle every customer interaction with a live agent. While this approach may score well in terms of the service quality, it likely would also be prohibitively expensive due to the high cost of agent labor. Because of this, most contact centers utilize automated processes in place of live agents, such as interactive voice response (IVR) systems, interactive media response (IMR) systems, internet robots or “bots”, automated chat modules or “chatbots”, and the like.

Referring specifically to FIG. 2, the contact center 200 may be used by a customer service provider to provide various types of services to customers. For example, the contact center 200 may be used to engage and manage interactions in which automated processes (or bots) or human agents communicate with customers. The contact center 200 may be an in-house facility of a business or enterprise for performing the functions of sales and customer service relative to products and services available through the enterprise. In another aspect, the contact center 200 may be operated by a service provider that contracts to provide customer relation services to a business or organization. Further, the contact center 200 may be deployed on equipment dedicated to the enterprise or third-party service provider, and/or deployed in a remote computing environment such as, for example, a private or public cloud environment with infrastructure for supporting multiple contact centers for multiple enterprises. The contact center 200 may include software applications or programs, which may be executed on premises or remotely or some combination thereof. It should further be appreciated that the various components of the contact center 200 may be distributed across various geographic locations.

Unless otherwise specifically limited, any of the computing elements of the present invention may be implemented in cloud-based or cloud computing environments. As used herein, “cloud computing” or, simply, the “cloud” is defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. Cloud computing can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.). Often referred to as a “serverless architecture”, a cloud execution model generally includes a service provider dynamically managing an allocation and provisioning of remote servers for achieving a desired functionality.

In accordance with the illustrated example of FIG. 2, the components or modules of the contact center 200 may include: a plurality of customer devices 205; communications network (or simply “network”) 210; switch/media gateway 212; call controller 214; interactive media response (IMR) server 216; routing server 218; storage device 220; statistics server 226; plurality of agent devices 230 that each have a workbin 232; multimedia/social media server 234; knowledge management server 236 coupled to a knowledge system 238; chat server 240; web servers 242; interaction server 244; universal contact server (or “UCS”) 246; reporting server 248; media services server 249; and an analytics module 250. It should be understood that any of the computer-implemented components, modules, or servers described in relation to FIG. 2 or in any of the following figures may be implemented via computing devices, such as the computing device 100 of FIG. 1. As will be seen, the contact center 200 generally manages resources (e.g., personnel, computers, telecommunication equipment, etc.) to enable the delivery of services via telephone, email, chat, or other communication mechanisms. The various components, modules, and/or servers of FIG. 2 (and other figures included herein) each may include one or more processors executing computer program instructions and interacting with other system components for performing the various functionalities described herein. Further, the terms “interaction” and “communication” are used interchangeably, and generally refer to any real-time and non-real-time interaction that uses any communication channel including, without limitation, telephone calls (PSTN or VoIP calls), emails, voicemails, video, chat, screen-sharing, text messages, social media messages, WebRTC calls, etc. Access to and control of the components of the contact system 200 may be affected through user interfaces (UIs) which may be generated on the customer devices 205 and/or the agent devices 230.

Customers desiring to receive services from the contact center 200 may initiate inbound communications (e.g., telephone calls, emails, chats, etc.) to the contact center 200 via a customer device 205. While FIG. 2 shows two such customer devices it should be understood that any number may be present. The customer devices 205, for example, may be a communication device, such as a telephone, smart phone, computer, tablet, or laptop. In accordance with functionality described herein, customers may generally use the customer devices 205 to initiate, manage, and conduct communications with the contact center 200, such as telephone calls, emails, chats, text messages, web-browsing sessions, and other multi-media transactions. Inbound and outbound communications from and to the customer devices 205 may traverse the network 210, with the nature of network typically depending on the type of customer device being used and form of communication. As an example, the network 210 may include a communication network of telephone, cellular, and/or data services. The network 210 may be a private or public switched telephone network (PSTN), local area network (LAN), private wide area network (WAN), and/or public WAN such as the Internet. Further, the network 210 may include a wireless carrier network including a code division multiple access network, global system for mobile communications (GSM) network, or any wireless network/technology conventional in the art.

The switch/media gateway 212 may be coupled to the network 210 for receiving and transmitting telephone calls between customers and the contact center 200. The switch/media gateway 212 may include a telephone or communication switch configured to function as a central switch for agent routing within the center. The switch may be a hardware switching system or implemented via software. For example, the switch 215 may include an automatic call distributor, a private branch exchange (PBX), an IP-based software switch, and/or any other switch with specialized hardware and software configured to receive Internet-sourced interactions and/or telephone network-sourced interactions from a customer, and route those interactions to, for example, one of the agent devices 230. In general, the switch/media gateway 212 establishes a voice connection between the customer and the agent by establishing a connection between the customer device 205 and agent device 230. The switch/media gateway 212 may be coupled to the call controller 214 which, for example, serves as an adapter or interface between the switch and the other routing, monitoring, and communication-handling components of the contact center 200. The call controller 214 may be configured to process PSTN calls, VoIP calls, etc. The call controller 214 may include computer-telephone integration (CTI) software for interfacing with the switch/media gateway and other components. The call controller 214 may extract data about an incoming interaction, such as the customer's telephone number, IP address, or email address, and then communicate these with other contact center components in processing the interaction.

The interactive media response (IMR) server 216 enables self-help or virtual assistant functionality. Specifically, the IMR server 216 may be similar to an interactive voice response (IVR) server, except that the IMR server 216 is not restricted to voice and may also cover a variety of media channels. In an example illustrating voice, the IMR server 216 may be configured with an IMR script for querying customers on their needs. Through continued interaction with the IMR server 216, customers may receive service without needing to speak with an agent. The IMR server 216 may ascertain why a customer is contacting the contact center so to route the communication to the appropriate resource.

The routing server 218 routes incoming interactions. For example, once it is determined that an inbound communication should be handled by a human agent, functionality within the routing server 218 may select the most appropriate agent and route the communication thereto. This type of functionality may be referred to as predictive routing. Such agent selection may be based on which available agent is best suited for handling the communication. More specifically, the selection of appropriate agent may be based on a routing strategy or algorithm that is implemented by the routing server 218. In doing this, the routing server 218 may query data that is relevant to the incoming interaction, for example, data relating to the particular customer, available agents, and the type of interaction, which, as described more below, may be stored in particular databases. Once the agent is selected, the routing server 218 may interact with the call controller 214 to route (i.e., connect) the incoming interaction to the corresponding agent device 230. As part of this connection, information about the customer may be provided to the selected agent via their agent device 230, which may enhance the service the agent is able to provide.

Regarding data storage, the contact center 200 may include one or more mass storage devices—represented generally by the storage device 220—for storing data in one or more databases. For example, the storage device 220 may store customer data that is maintained in a customer database 222. Such customer data may include customer profiles, contact information, service level agreement (SLA), and interaction history (e.g., details of previous interactions with a particular customer, including the nature of previous interactions, disposition data, wait time, handle time, and actions taken by the contact center to resolve customer issues). As another example, the storage device 220 may store agent data in an agent database 223. Agent data maintained by the contact center 200 may include agent availability and agent profiles, schedules, skills, average handle time, etc. As another example, the storage device 220 may store interaction data in an interaction database 224. Interaction data may include data relating to numerous past interactions between customers and contact centers. More generally, it should be understood that, unless otherwise specified, the storage device 220 may be configured to include databases and/or store data related to any of the types of information described herein, with those databases and/or data being accessible to the other modules or servers of the contact center 200 in ways that facilitate the functionality described herein. For example, the servers or modules of the contact center 200 may query such databases to retrieve data stored therewithin or transmit data thereto for storage.

The statistics server 226 may be configured to record and aggregate data relating to the performance and operational aspects of the contact center 200. Such information may be compiled by the statistics server 226 and made available to other servers and modules, such as the reporting server 248, which then may produce reports that are used to manage operational aspects of the contact center and execute automated actions in accordance with functionality described herein. Such data may relate to the state of contact center resources, e.g., average wait time, abandonment rate, agent occupancy, and others as functionality described herein would require.

The agent devices 230 of the contact center 200 may be communication devices configured to interact with the various components and modules of the contact center 200 to facilitate the functionality described herein. An agent device 230, for example, may include a telephone adapted for regular telephone calls or VoIP calls. An agent device 230 may further include a computing device configured to communicate with the servers of the contact center 200, perform data processing associated with operations, and interface with customers via voice, chat, email, and other multimedia communication mechanisms according to functionality described herein. While only two such agent devices are shown, any number may be present.

The multimedia/social media server 234 may be configured to facilitate media interactions (other than voice) with the customer devices 205 and/or the servers 242. Such media interactions may be related, for example, to email, voicemail, chat, video, text-messaging, web, social media, co-browsing, etc. The multi-media/social media server 234 may take the form of any IP router conventional in the art with specialized hardware and software for receiving, processing, and forwarding multi-media events and communications.

The knowledge management server 234 may be configured to facilitate interactions between customers and the knowledge system 238. In general, the knowledge system 238 may be a computer system capable of receiving questions or queries and providing answers in response. The knowledge system 238 may include an artificially intelligent computer system capable of answering questions posed in natural language by retrieving information from information sources such as encyclopedias, dictionaries, newswire articles, literary works, or other documents submitted to the knowledge system 238 as reference materials, as is known in the art.

The chat server 240 may be configured to conduct, orchestrate, and manage electronic chat communications with customers. Such chat communications may be conducted by the chat server 240 in such a way that a customer communicates with automated chatbots, human agents, or both. The chat server 240 may perform as a chat orchestration server that dispatches chat conversations among chatbots and available human agents. In such cases, the processing logic of the chat server 240 may be rules driven so to leverage an intelligent workload distribution among available chat resources. The chat server 240 further may implement, manage and facilitate user interfaces (also UIs) associated with the chat feature. The chat server 240 may be configured to transfer chats within a single chat session with a particular customer between automated and human sources. The chat server 240 may be coupled to the knowledge management server 234 and the knowledge systems 238 for receiving suggestions and answers to queries posed by customers during a chat so that, for example, links to relevant articles can be provided.

The web servers 242 provide site hosts for a variety of social interaction sites to which customers subscribe, such as Facebook, Twitter, Instagram, etc. Though depicted as part of the contact center 200, it should be understood that the web servers 242 may be provided by third parties and/or maintained remotely. The web servers 242 may also provide webpages for the enterprise or organization being supported by the contact center 200. For example, customers may browse the webpages and receive information about the products and services of a particular enterprise. Within such enterprise webpages, mechanisms may be provided for initiating an interaction with the contact center 200, for example, via web chat, voice, or email. An example of such a mechanism is a widget, which can be deployed on the webpages or websites hosted on the web servers 242. As used herein, a widget refers to a user interface component that performs a particular function. In some implementations, a widget includes a GUI that is overlaid on a webpage displayed to a customer via the Internet. The widget may show information, such as in a window or text box, or include buttons or other controls that allow the customer to access certain functionalities, such as sharing or opening a file or initiating a communication. In some implementations, a widget includes a user interface component having a portable portion of code that can be installed and executed within a separate webpage without compilation. Such widgets may include additional user interfaces and be configured to access a variety of local resources (e.g., a calendar or contact information on the customer device) or remote resources via network (e.g., instant messaging, electronic mail, or social networking updates).

The interaction server 244 is configured to manage deferrable activities of the contact center and the routing thereof to human agents for completion. As used herein, deferrable activities include back-office work that can be performed off-line, e.g., responding to emails, attending training, and other activities that do not entail real-time communication with a customer.

The universal contact server (UCS) 246 may be configured to retrieve information stored in the customer database 222 and/or transmit information thereto for storage therein. For example, the UCS 246 may be utilized as part of the chat feature to facilitate maintaining a history on how chats with a particular customer were handled, which then may be used as a reference for how future chats should be handled. More generally, the UCS 246 may be configured to facilitate maintaining a history of customer preferences, such as preferred media channels and best times to contact. To do this, the UCS 246 may be configured to identify data pertinent to the interaction history for each customer, such as data related to comments from agents, customer communication history, and the like. Each of these data types then may be stored in the customer database 222 or on other modules and retrieved as functionality described herein requires.

The reporting server 248 may be configured to generate reports from data compiled and aggregated by the statistics server 226 or other sources. Such reports may include near real-time reports or historical reports and concern the state of contact center resources and performance characteristics, such as, for example, average wait time, abandonment rate, agent occupancy. The reports may be generated automatically or in response to a request and used toward managing the contact center in accordance with functionality described herein.

The media services server 249 provides audio and/or video services to support contact center features. In accordance with functionality described herein, such features may include prompts for an IVR or IMR system (e.g., playback of audio files), hold music, voicemails/single party recordings, multi-party recordings (e.g., of audio and/or video calls), speech recognition, dual tone multi frequency (DTMF) recognition, audio and video transcoding, secure real-time transport protocol (SRTP), audio or video conferencing, call analysis, keyword spotting, etc.

The analytics module 250 may be configured to perform analytics on data received from a plurality of different data sources as functionality described herein may require. The analytics module 250 may also generate, update, train, and modify predictors or models, such as machine learning model 251 and/or models 253, based on collected data. To achieve this, the analytics module 250 may have access to the data stored in the storage device 220, including the customer database 222 and agent database 223. The analytics module 250 also may have access to the interaction database 224, which stores data related to interactions and interaction content (e.g., audio and transcripts of the interactions and events detected therein), interaction metadata (e.g., customer identifier, agent identifier, medium of interaction, length of interaction, interaction start and end time, department, tagged categories), and the application setting (e.g., the interaction path through the contact center). The analytic module 250 may retrieve such data from the storage device 220 for developing and training algorithms and models. It should be understood that, while the analytics module 250 is depicted as being part of a contact center, the functionality described in relation thereto may also be implemented on customer systems (or, as also used herein, on the “customer-side” of the interaction) and used for the benefit of customers.

The machine learning model 251 may include one or more artificial intelligence-based models, including machine learning models, such as neural networks, deep learning models as well as other types as described herein. As an example, the machine learning model 251 may be configured to predict behavior. Such behavioral models may be trained to predict the behavior of customers and agents in a variety of situations so that interactions may be personally tailored to customers and handled more efficiently by agents. As another example, the machine learning model 251 may be configured to predict aspects related to contact center operation and performance. In other cases, for example, the machine learning model 251 also may be configured to perform natural language processing and, for example, provide intent recognition and the like.

The analytics module 250 may further include an optimization system 252. The optimization system 252 may include one or more models 253, which may include the machine learning model 251, and an optimizer 254. The optimizer 254 may be used in conjunction with the models 253 to minimize a cost function subject to a set of constraints, where the cost function is a mathematical representation of desired objectives or system operation. Because the models 253 are typically non-linear, the optimizer 254 may be a nonlinear programming optimizer. It is contemplated, however, that the optimizer 254 may be implemented by using, individually or in combination, a variety of different types of optimization approaches, including, but not limited to, linear programming, quadratic programming, mixed integer non-linear programming, stochastic programming, global non-linear programming, genetic algorithms, particle/swarm techniques, and the like. The analytics module 250 may utilize the optimization system 252 as part of an optimization process by which aspects of contact center performance and operation are optimized or, at least, enhanced. This, for example, may include aspects related to the customer experience, agent experience, interaction routing, natural language processing, intent recognition, allocation of system resources, system analytics, or other functionality related to automated processes.

### Context-Aware Assistant

The present disclosure relates to systems and methods for providing context-aware assistance in a contact center platform. Contact centers serve as infrastructure for organizations to manage interactions with customers across various communication channels, including voice calls, text messaging, web chat, email, and social media. Supervisors within contact centers may be responsible for ensuring agent compliance, service quality, and overall customer satisfaction. To fulfill these responsibilities, supervisors may review interaction data, evaluate agent performance using quality management forms, and provide feedback and coaching. Supervisors may also manage agent assignments, update skill profiles, and modify queue memberships to ensure that routing logic remains aligned with agent capabilities and organizational objectives

Tasks (e.g., supervisory tasks) in contact centers may be manual, repetitive, and labor-intensive, particularly as the scale and complexity of contact center operations increase. The systems and methods described herein may address these challenges by providing context-aware assistance that enables supervisors to perform administrative and operational tasks efficiently while maintaining awareness of current operational context.

To do so, in accordance with an embodiment of the present disclosure, a context-aware assistant (i.e., an artificial intelligence (AI)-based context-aware tool) may be integrated into a contact center platform to assist a user (e.g., a supervisor) in performing one or more supervisory tasks. The context-aware assistant is configured to perform operations requested by the user based on contextual information associated with the user without having to navigate away from the current view of the platform interface. More specifically, the context-aware assistant is configured to execute operations requested by a user by determining contextual information associated with the user. For example, the contextual information may include, but is not limited to, a role of the user within the contact center, the current application context based on user interaction data within the contact center platform, metadata associated with those interactions, historical usage patterns, and/or the present operational context of the contact center.

By way of example, the role of the user may be evaluated to determine whether the user satisfies authentication and authorization requirements necessary to execute the requested operation. In some cases, when a user is not authorized to perform a requested operation, the systems and methods may determine an authorized person who is authorized to perform the requested operation and may generate a work item to create a task for the authorized person to approve the user to perform the requested operation. The user interaction data may include an active portion of the GUI that is currently visible to the user, a location of the user within the contact center platform interface, a workflow state which describes a current step or stage within a process or task flow that the user is engaged in, and/or a user navigation path within the GUI. Additionally, the context-aware assistant may monitor interface state data, user navigation patterns, active modules, or workflow steps to infer the operational context of the contact center in which supervisory tasks are being performed. This contextual information can be used to dynamically adjust the content, functionality, or recommendations presented to the user. For example, based on the current application context, the context-aware assistant may execute administrative workflows, surface relevant operational insights, and/or generate recommendations without having to navigate away from the current view of the platform interface.

The requested operations that may be performed through the context-aware assistant may include retrieving information, managing one or more users, or managing work items. Retrieving information may include accessing one or more knowledge bases associated with an organization of the user and filtering the retrieved information based on the current application context. Managing one or more users may include adding new users, managing attributes for users to ensure routing behavior and user skill profiles align with operational needs, assigning or removing users from queues to control how interactions are distributed and ensure staffing aligns with demand, assigning or revoking user roles to control access to features and enforce proper authorization boundaries across an organization, or assigning or updating user phone configurations or station settings to ensure compatibility with telephony and voice interaction workflows. Managing work items may include creating, assigning, tracking, and updating one or more tasks associated with user interactions or operational workflows based on the requested operation.

In some cases, the context-aware assistant may accept user input expressed in natural language and may process the user input to determine an intent associated with the requested operation. The systems and methods may also automatically generate work items for users based on user context data, including detecting performance anomalies based on user context data and automatically creating work items in response to anomaly detection.

Additionally, in accordance with an embodiment of the present disclosure, the context-aware assistant is configured to automatically detect and create a case (also referred to as a work item) based on criteria of incoming or outgoing interactions. The context-aware assistant may integrate with a case management system to recommend and/or auto-generate a case. In other words, the context-aware assistant and the case management system are configured to greatly assist in accelerating the required workstreams required to satisfy the customer intent and achieve the required business outcomes.

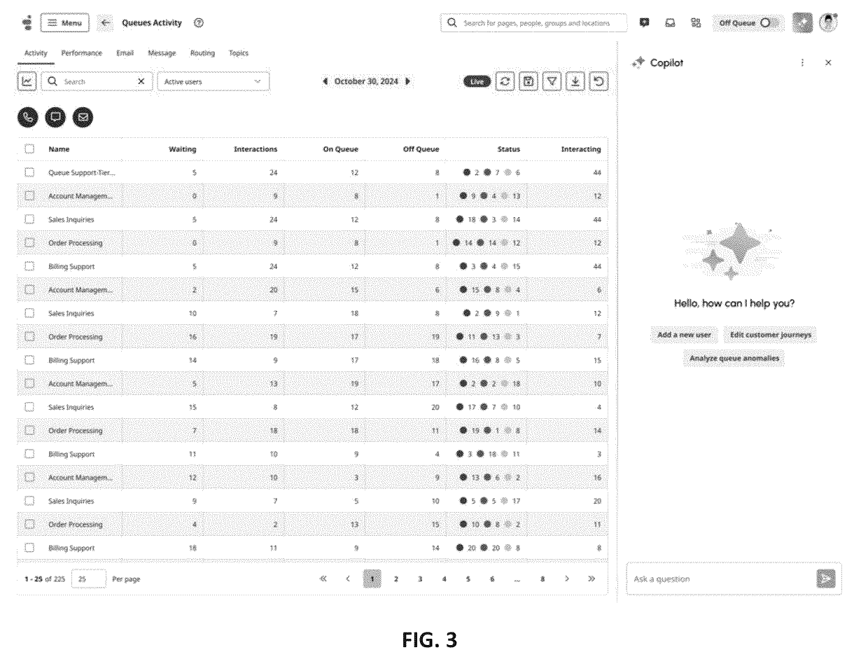

Referring now to FIG. 3, an exemplary graphical user interface (GUI) of a computing device (e.g., the computing device 100, the contact center system 200, and/or other computing devices described herein) is depicted displaying a queues activity view with an integrated assistant panel. The queue activity view shows activities of multiple queues within a contact center platform (e.g., the contact center system 200 or other cloud-based contact center platform), which includes a context-aware assistant with an integrated assistant panel.

The graphical user interface includes a collapsible side panel containing a context-aware assistant, referred to as a Copilot panel. The Copilot panel is accessible as a side panel within the graphical user interface that can be expanded or collapsed while the user remains on their current view. The Copilot panel, when expanded, displays an icon (e.g., an animated icon) and a greeting message prompting the user for input. The Copilot panel includes selectable action buttons for common supervisory operations such as adding a new user, editing customer journeys, and analyzing queue anomalies. A text input field at the bottom of the Copilot panel allows users to submit questions or requests in natural language.

As described previously, the context-aware assistant is configured to determine user context data associated with a user of a contact center. For example, the user context data may include a role of the user within a contact center, a current application context based on user interaction data within the contact center platform, metadata associated with those interactions, historical usage patterns, and/or a present operational context of the contact center. To determine the user context data, the context-aware assistant receives user interaction data of the user indicating navigation within the graphical user interface of the contact center platform and determine the current application context based on the user interaction data.

For example, when a user navigates to the queues activity view as shown in FIG. 3, the system may receive user interaction data indicating that the user has accessed queue management functionality. The user interaction data may include an active portion of the graphical user interface that is currently visible to the user, such as the queues activity table; a workflow state which describes a current step or stage within a predefined process or task flow that the user is engaged in, such as monitoring queue performance; and/or a user navigation path within the graphical user interface indicating how the user arrived at the current view.

Based on the user interaction data, the system may determine that the current application context corresponds to queue management operations. The context-aware assistant may utilize this current application context to provide contextually relevant assistance to the user. For example, when the user is viewing the queues activity view, the context-aware assistant may present action options related to queue management, such as reassigning agents to queues experiencing high wait times or analyzing queue anomalies. The integration of the Copilot panel within the queues activity view enables users to perform operations and receive assistance without navigating away from their current workflow, thereby maintaining visibility of operational metrics while executing supervisory tasks.

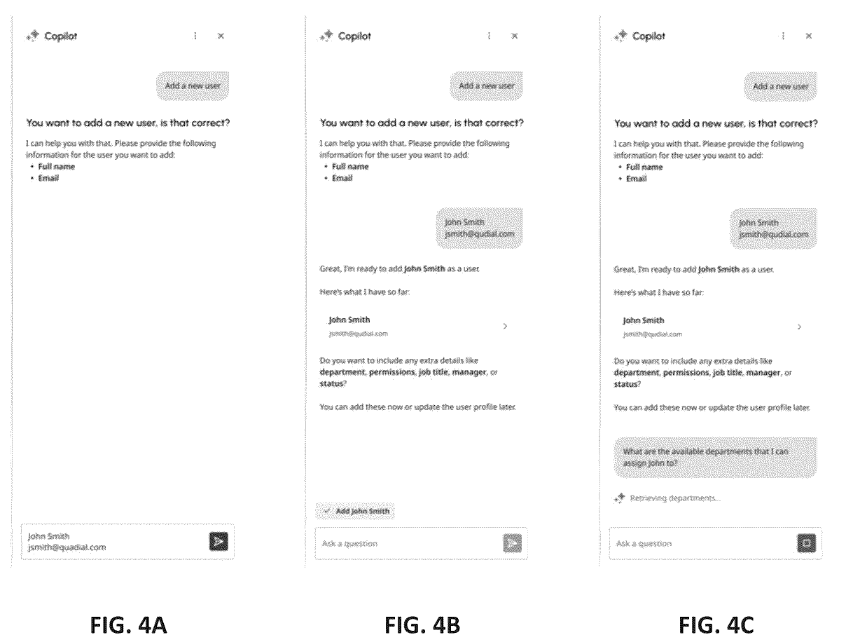

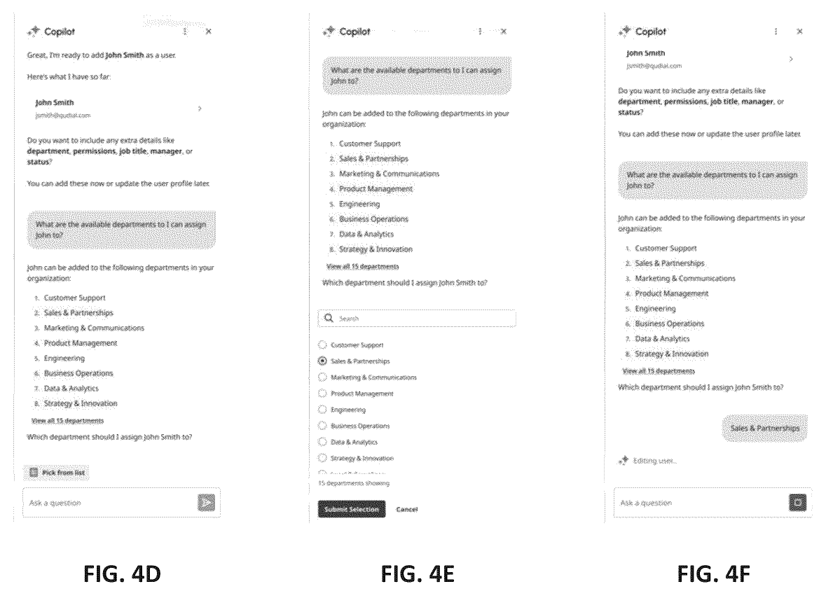

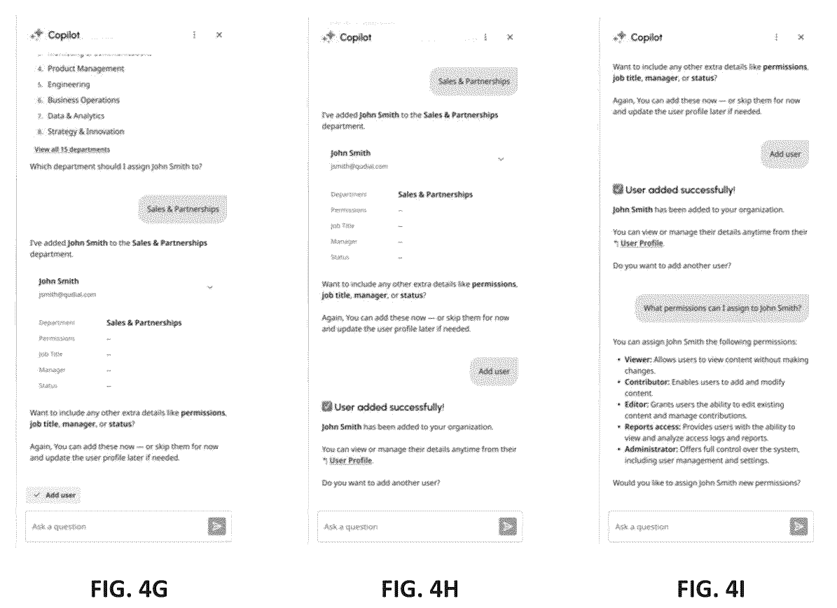

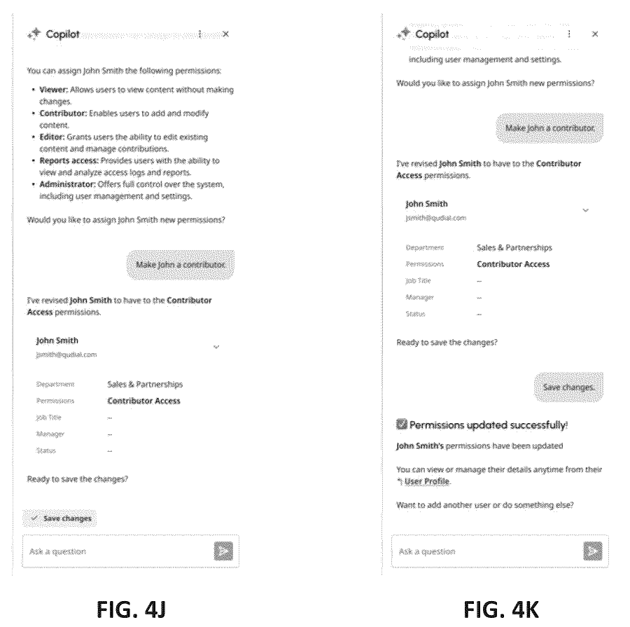

Turning now to FIGS. 4-6, exemplary screenshots of the graphical user interface (GUI) of a computing device (e.g., the computing device 100, the contact center system 200, and/or other computing devices described herein) are shown to illustrate features of the context-aware assistant of a contact center platform (e.g., the contact center system 200 or other cloud-based contact center platform).

Referring to FIGS. 4A-4C, a sequence of user interface screens is depicted showing a Copilot assistant panel for adding a new user within a contact center platform, in accordance with an embodiment of the present disclosure. The sequence illustrates how the context-aware assistant receives a user input from the user on an interface view indicative of a requested operation, where the requested operation includes managing one or more users.

As shown in FIG. 4A, the Copilot panel displays an initial state where a user has submitted a request to add a new user. The user input may be expressed in natural language, and the system processes the user input to determine an intent associated with the requested operation. In the depicted example, the user has entered a natural language request to add a new user, and the context-aware assistant has processed this input to determine that the intent corresponds to a user management operation for creating a new user account within the contact center platform.

The Copilot panel displays a confirmation message asking if the user wants to add a new user and lists the information fields that are required to complete the operation, including full name and email. The context-aware assistant may provide step-by-step instructions based on Resource Center knowledge to guide the user (e.g., administrators and supervisors) in configuring and managing the contact center platform. A text input field at the bottom of the panel shows that the user has entered a name and an email address in response to the clarification query.

As shown in FIG. 4B, a subsequent state of the Copilot panel is depicted after the user has submitted the requested information. The system determines operational context data. For example, the operational context data includes contextually relevant information associated with the requested operation based on a role of the user and the current application context. The panel displays a confirmation that the system is ready to add the specified user and presents a summary card showing the name and email address that were provided. The panel also prompts the user regarding whether additional details should be included, such as department, permissions, job title, manager, or status, and indicates that these details can be added at the current time or updated later in the user profile. A button for completing the user addition operation appears at the bottom of the panel.

As further shown in FIG. 4C, a further state of the Copilot panel is depicted where the user has asked a follow-up question about available departments. The panel displays the same user summary card and the question about extra details. Below this information, the user has typed a question asking what available departments can be assigned to the new user. The panel shows a status indicator that the system is retrieving departments in response to the query. The context-aware assistant retrieves contextually relevant information including available departments based on the role of the user and the current application context. This retrieval operation enables the user to access organizational configuration data without navigating away from the current interface view, thereby maintaining the workflow continuity while gathering the information needed to complete the user management operation.

Referring now to FIGS. 4D-4F, a sequence of interface views is depicted illustrating a department selection workflow within the Copilot assistant panel. The sequence demonstrates how the context-aware assistant presents available departments based on the organization's configuration and guides the user through the selection process to complete the user management operation.

As shown in FIG. 4D, the Copilot panel displays a response to the user's query about available departments. The context-aware assistant presents a numbered list of departments available within the organization, including Customer Support, Sales and Partnerships, Marketing & Communications, Product Management, Engineering, Business Operations, Data and Analytics, and Strategy & Innovation. The panel indicates that additional departments are available and provides an option to view all fifteen departments. The context-aware assistant prompts the user to indicate which department the new user should be assigned to, and a button labeled “Pick from list” is displayed at the bottom of the interface along with a text input field for asking questions.

As described previously, performing the requested operation based on the operational context data without navigating away from the interface view may include determining whether additional information is required to complete the requested operation based on the user context data. In the depicted example, the system has determined that department assignment information is required to complete the user creation operation. In response to determining that additional information is required, the system generates a clarification query requesting the additional information from the user. The clarification query in FIG. 4D asks which department the new user should be assigned to, thereby prompting the user to provide the department selection needed to proceed with the operation. In response, the user may type the department selection in the text input field or select the button labeled “Pick from list” to select it from the expanded department selection interface.

In response to the selection of the button labeled “Pick from list,” the expanded department selection interface is present to the user in the panel, as shown in FIG. 4E. The expanded department selection interface includes the list of departments with radio button selectors displayed next to each department name. A search field allows filtering of departments to locate specific entries within the list. The interface indicates that fifteen departments are available and includes “Submit Selection” and “Cancel” buttons at the bottom. In the depicted example, the Sales and Partnerships department is shown as selected via the radio button selector. The system receives the additional information from the user through the department selection interface, enabling the user to specify the department assignment without navigating away from the current interface view.

As further shown in FIG. 4F, the Copilot panel displays the completed selection workflow. The interface shows the user information for the new user at the top with navigation controls. The panel displays the same prompt about including extra details, followed by the user query about available departments and the assistant response listing the available departments. The prompt asking which department to assign the new user to is followed by a selection showing Sales and Partnerships as the chosen department. A status indicator shows “Editing user,” indicating that the system is processing the selection to update the user profile with the department assignment. A text input field for asking questions appears at the bottom of the interface, enabling the user to continue interacting with the context-aware assistant while the profile update is being processed.

The department selection workflow depicted in FIGS. 4D-4F demonstrates how the context-aware assistant provides step-by-step guidance throughout the selection process. The context-aware assistant first presents the available options based on the organization's configuration, then provides an interactive selection mechanism, and finally processes the selection to update the user profile. Throughout this workflow, the user remains on the same interface view, maintaining visibility of the operation progress while the system gathers and processes the information needed to complete the user management operation.

Referring to FIGS. 4G-4K, a sequence of interface views is depicted illustrating the completion of the user creation workflow and the subsequent permission assignment process within the Copilot assistant panel. The sequence demonstrates how the system processes the requested operation with the additional information to generate a response corresponding to completion of the requested operation and provides the response to the user via the interface view.

As shown in FIG. 4G, the Copilot panel displays a confirmation message indicating that the new user has been added to the Sales and Partnerships department. The interface presents a user profile card displaying the name, email address, and the assigned department. Additional fields for permissions, job title, manager, and status are shown with placeholder values, indicating that these attributes may be configured as part of the user management operation. The interface prompts the user about including additional details such as permissions, job title, manager, or status, with an option to add these attributes at the current time or skip and update the user profile later. An “Add user” button appears at the bottom of the panel, enabling the user to complete the user creation operation.

In response to the selection of the “Add user” button, the Copilot panel displays a success notification indicating that the user has been added to the organization, as shown in FIG. 4H. The notification includes a message confirming the successful completion of the user creation operation and provides a link to the user profile for viewing or managing details. The interface asks if the user wants to add another user, enabling the user to continue with additional user management operations without navigating away from the current interface view. The system provides the response to the user via the interface view by displaying the success notification and the link to the newly created user profile.

As further shown in FIG. 4I, the Copilot panel displays a continuation of the workflow where the user has asked a follow-up question about available permissions. The user has submitted a natural language query asking what permissions can be assigned to the newly created user. The context-aware assistant responds with a list of available permissions including Viewer, Contributor, Editor, Reports access, and Administrator, with descriptions of each permission type. The Viewer permission allows users to view content without making changes. The Contributor permission enables users to add and modify content. The Editor permission grants users the ability to edit existing content and manage contributions. The Reports access permission provides users with the ability to view and analyze access logs and reports. The Administrator permission offers full control over the system including user management and settings. The context-aware assistant asks if the user would like to assign a specific permission level to the newly created user, with a text input field at the bottom for additional questions. As described previously, managing one or more users includes assigning or revoking user roles to control access to features and enforce proper authorization boundaries across an organization.

In response, the user may type “Make John a contributor.” in the text input field. The interface displays a confirmation message indicating that the user has been revised to have Contributor Access permissions, along with a user information card showing the email address, department, and the updated permissions field, as shown in FIG. 4J. A prompt further asks if the user is ready to save the changes, with a “Save changes” button displayed below.

The context-aware assistant is configured to log metadata when performing the requested operation. When the user (e.g., an administrator or a supervisor) assigns permissions to the new user, the system records metadata associated with the permission assignment operation, including the identity of the user who performed the action, the timestamp of the operation, the specific permission level assigned, and the user account that was modified. This metadata logging enables audit trails and compliance tracking for supervisory actions taken through the system. The logged metadata may be stored in the interaction database and may be accessed through reporting functionality to review the history of user management operations performed within the contact center platform.

Once the user selects the “Save changes” button, the system provides the response to the user via the interface view by displaying the confirmation message and the updated user profile card showing the assigned permission level, as shown in FIG. 4K. It should be appreciated that, throughout this permission assignment workflow, the user remains on the same interface view, maintaining visibility of the operation progress while the system processes the permission assignment and logs the associated metadata for audit and compliance purposes.

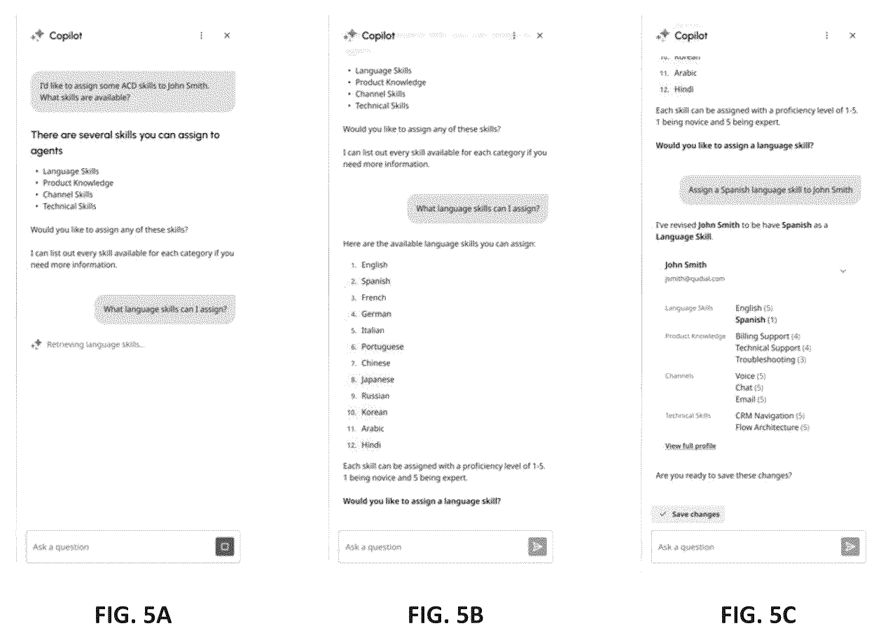

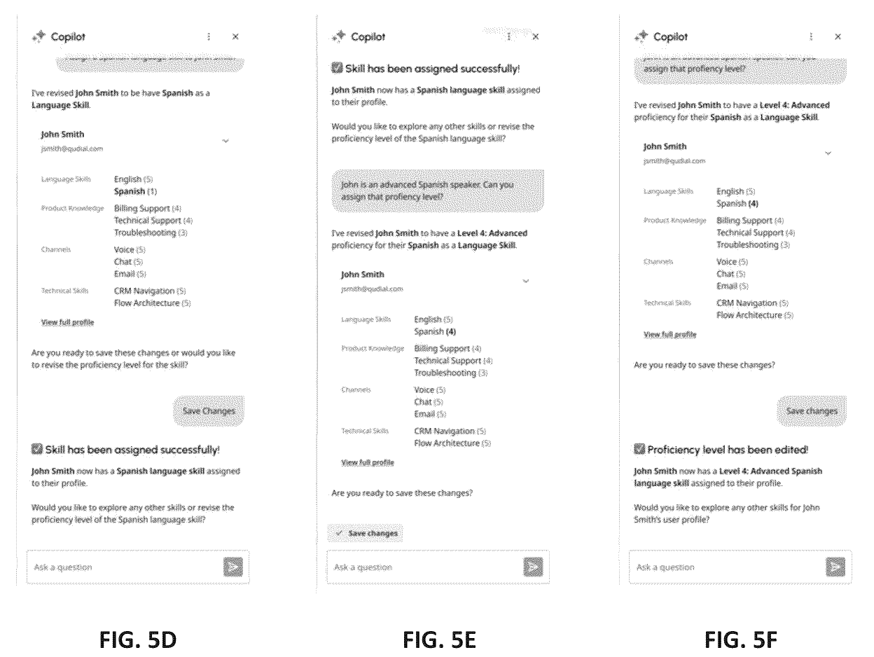

Referring to FIGS. 5A-5F, a sequence of user interface screens is depicted showing a Copilot assistant panel for assigning skills to a user within a contact center platform, in accordance with an embodiment of the present disclosure. The sequence illustrates how the context-aware assistant facilitates managing attributes for agents to ensure agent skill profiles and routing behavior align with operational needs.

As shown in FIG. 5A, the Copilot panel displays an initial state where a user has submitted a request to assign skills to an agent. The user has entered a natural language request to assign skills to a specified agent, and the context-aware assistant has processed this input to determine that the intent corresponds to a user management operation for configuring skill assignments. The context-aware assistant responds by listing several skill categories available for assignment, including Language Skills, Product Knowledge, Channel Skills, and Technical Skills. The context-aware assistant offers to list every skill available for each category and indicates that the system is retrieving language skills in response to a user query requesting additional information about available language options.

The skill categories presented by the context-aware assistant correspond to different aspects of agent capabilities within the contact center platform. Language Skills define the languages in which an agent can communicate with customers, enabling routing of interactions to agents who can serve customers in their preferred language. Product Knowledge skills indicate an agent's familiarity with specific product areas such as billing support, technical support, and troubleshooting, enabling routing of interactions to agents with relevant expertise. Channel Skills define the communication channels through which an agent can handle interactions, such as voice, chat, and email. Technical Skills indicate an agent's proficiency with specific tools and systems used within the contact center, such as CRM navigation and flow architecture.

Referring to FIG. 5B, the Copilot panel displays a subsequent state where the system has retrieved and presented the available language skills. The panel displays a numbered list of twelve available language skills that can be assigned, including English, Spanish, French, German, Italian, Portuguese, Chinese, Japanese, Russian, Korean, Arabic, and Hindi. The context-aware assistant explains that each skill can be assigned with a proficiency level ranging from one to five, with one being novice and five being expert. The proficiency level assignment enables the routing server to match interactions with agents based on both skill possession and skill proficiency, ensuring that interactions requiring higher proficiency levels are routed to appropriately qualified agents. The context-aware assistant asks if the user would like to assign a language skill, prompting the user to specify which skill should be added to the agent profile.

As described previously, the system determines if the user is authorized to perform the requested operation based on the role of the user. When the user requests to assign skills to an agent, the system evaluates the user's role to verify that the user has the authorization to modify agent skill profiles. The authorization determination may be based on the user's assigned permissions within the contact center platform, the organizational hierarchy defining which agents the user can manage, and the specific skill categories that the user is permitted to configure.

As further shown in FIG. 5C, the Copilot panel displays the completion of the skill assignment workflow where the user has requested to assign a Spanish language skill to the specified agent. In response to determining that the user is authorized, the system performs the requested operation based on the operational context data without navigating away from the interface view. The context-aware assistant confirms the revision and displays a profile card for the agent showing the updated skill assignments. The profile card displays Language Skills with English at proficiency level five and Spanish at proficiency level one, indicating that the new skill has been added with an initial proficiency level. The profile card also displays Product Knowledge skills including Billing Support, Technical Support, and Troubleshooting at various proficiency levels, Channel skills including Voice, Chat, and Email at proficiency level five, and Technical Skills including CRM Navigation and Flow Architecture at proficiency level five. The profile card includes a link to view the full profile and a save changes button to confirm the modifications.

The skill assignment workflow depicted in FIGS. 5A-5C demonstrates how the context-aware assistant enables users (e.g., supervisors) to manage user attributes that affect routing behavior within the contact center platform. By presenting available skill categories, listing specific skills within each category, and enabling proficiency level assignment, the context-aware assistant provides a guided workflow for configuring agent skill profiles. Throughout this workflow, the agent remains on the same interface view, maintaining visibility of the operation progress while the system processes the skill assignment and updates the agent profile to align with operational needs.

Referring to FIGS. 5D-5F, a sequence of interface views is depicted illustrating a proficiency level modification workflow within the Copilot assistant panel. The sequence demonstrates how the context-aware assistant enables users to modify skill proficiency levels for agents after initial skill assignment, with the system determining authorization and performing the operation without navigating away from the interface view.

As shown in FIG. 5D, the Copilot panel displays a confirmation that a skill has been assigned, indicating that the agent now has a Spanish language skill assigned to the agent profile. The interface displays the agent profile information including an email address, language skills showing English with a proficiency level of five and Spanish with a proficiency level of one, product knowledge categories including Billing Support, Technical Support, and Troubleshooting with respective proficiency levels, communication channels including Voice, Chat, and Email each with proficiency levels of five, and technical skills including CRM Navigation and Flow Architecture each with proficiency levels of five. A link to view the full profile is provided. The interface prompts the user asking if the user would like to explore any other skills or revise the proficiency level of the Spanish language skill.

As shown in FIG. 5E, the user has submitted a natural language input requesting that the proficiency level be changed because the agent is an advanced Spanish speaker. The system processes the user input to determine an intent associated with the requested operation, identifying that the user intends to modify the proficiency level of the previously assigned Spanish language skill for the agent. The context-aware assistant responds that the system has revised the agent to have a Level 4 Advanced proficiency for the Spanish language skill and displays an updated agent profile card showing Spanish with a proficiency level of four. A prompt asks if the user is ready to save these changes, with a save changes option displayed and marked as confirmed.

As shown in FIG. 5F, the Copilot panel displays a continuation of the workflow where the user has requested assignment of an advanced proficiency level. The system determines if the user is authorized to perform the requested operation based on the role of the user. The authorization determination evaluates whether the user has permission to modify skill proficiency levels for the specified agent within the contact center platform. In response to determining that the user is authorized, the system performs the requested operation based on the operational context data without navigating away from the interface view.

The context-aware assistant confirms that the system has revised the agent to have a Level 4 Advanced proficiency for the Spanish language skill. The displayed agent profile card shows the updated information with Spanish now reflecting a proficiency level of four. The interface includes the same categories of language skills, product knowledge, channels, and technical skills with respective proficiency levels. A link to view the full profile is provided, and the interface asks if the user is ready to save these changes with a save changes button displayed. The save changes button enables the user to confirm the proficiency level modification and persist the updated skill configuration to the agent profile.

As further shown in FIG. 5F, the Copilot panel displays a success confirmation message indicating that the proficiency level has been edited. The confirmation states that the agent now has a Level 4 Advanced Spanish language skill assigned to the agent profile. The system processes the requested operation with the additional information to generate a response corresponding to completion of the requested operation and provides the response to the user via the interface view. The agent profile card displays the complete updated information including the email address, language skills with English at proficiency level five and Spanish at proficiency level four, product knowledge categories, communication channels, and technical skills with respective proficiency levels. A link to view the full profile is provided.

The interface concludes by asking if the user would like to explore any other skills for the agent profile, with a text input field at the bottom for asking additional questions. This prompt enables the user to continue with additional skill management operations without navigating away from the current interface view, thereby maintaining workflow continuity while managing agent attributes that affect routing behavior within the contact center platform.

The proficiency level modification workflow depicted in FIGS. 5D-5F demonstrates how the context-aware assistant enables users (e.g., administrator or supervisors) to adjust skill proficiency levels based on agent capabilities. The workflow accepts natural language input describing the agent's skill level, determines the appropriate proficiency level based on the input, updates the agent profile with the revised proficiency level, and confirms the changes through a save operation. Throughout this workflow, the user remains on the same interface view, and the system logs metadata associated with the proficiency level modification for audit and compliance purposes.

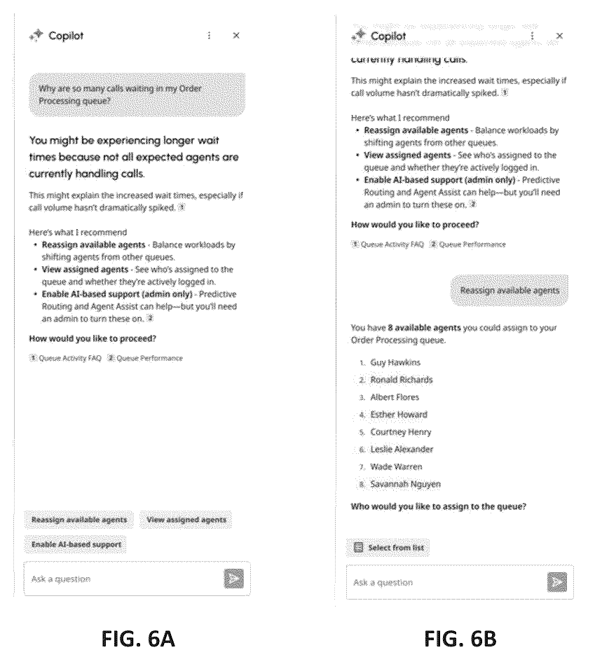

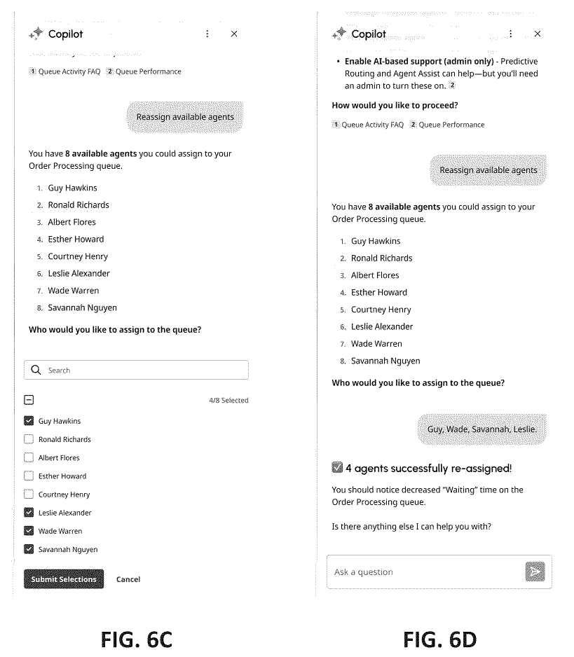

Referring to FIGS. 6A-6D, a sequence of interface views is depicted illustrating a queue anomaly analysis and agent reassignment workflow within the Copilot assistant panel, in accordance with an embodiment of the present disclosure. The sequence demonstrates how the context-aware assistant retrieves information by accessing one or more knowledge bases associated with an organization of the user and filters the retrieved information based on the current application context.

As shown in FIG. 6A, the Copilot panel displays a response to a user query asking why there are many calls waiting in an Order Processing queue. The user (e.g., a supervisor) has submitted a natural language query requesting information about queue performance, and the context-aware assistant has processed this input to determine that the intent corresponds to retrieving information about queue anomalies. The context-aware assistant responds with an explanation that longer wait times may be occurring because not all expected agents are currently handling calls, noting that call volume has not dramatically spiked. The response includes recommendations such as reassigning available agents to balance workloads by shifting agents from other queues, viewing assigned agents to see who is assigned to the queue and whether the agents are actively logged in, and enabling AI-based support for admin users through Predictive Routing and Agent Assist features.

To do so, the context-aware assistant accesses one or more knowledge bases associated with the organization of the user to retrieve information relevant to the queue anomaly. The knowledge bases may include documentation stored in the knowledge system, operational metrics collected by the statistics server, and configuration data associated with queue assignments and agent availability. The accessing is subject to permission constraints associated with the role of the user, such that the context-aware assistant retrieves and presents information that the user is authorized to view based on the user's assigned permissions within the contact center platform. For example, a user may be permitted to view queue performance metrics and agent availability information for queues within the user's organizational scope, while information about queues outside the user's scope may be filtered from the response.

As shown in FIG. 6A, the Copilot panel displays reference indicators and presents a question asking how the user would like to proceed, with links to Queue Activity FAQ and Queue Performance resources. At the bottom of the panel, three action buttons are displayed for reassigning available agents, viewing assigned agents, and enabling AI-based support, along with a text input field for asking additional questions. The context-aware assistant is presented within a Copilot interface that provides recommendations or auto-generation of cases or work items on behalf of the user. In the depicted example, the context-aware assistant provides recommendations for addressing the queue anomaly, enabling the user to select an appropriate action based on the operational context.

As shown in FIG. 6B, a subsequent state of the Copilot panel is depicted after the user has selected the reassign available agents option. In response to the selection of “Reassign available agents” action button, the context-aware assistant presents a list of eight available agents who could be assigned to the Order Processing queue, including Guy Hawkins, Ronald Richards, Albert Flores, Esther Howard, Courtney Henry, Leslie Alexander, Wade Warren, and Savannah Nguyen. The panel prompts the user to indicate who the user would like to assign to the queue and provides a “Select from list” button for making the selection, along with a text input field at the bottom for asking additional questions.

In other words, the context-aware assistant filters the retrieved information based on the current application context by presenting agents who are available for reassignment to the queue. The filtering operation considers agent availability status, current queue assignments, skill qualifications for the queue, and organizational constraints that determine which agents the user is authorized to reassign. The filtered list of available agents enables the user to make an informed decision about which agents to reassign without navigating away from the current interface view.

As shown in FIG. 6C, the Copilot panel displays an expanded selection interface where the user has activated the agent selection list. The user message bubble displays the text “Reassign available agents” indicating the requested operation. The system responds with information stating that there are eight available agents that could be assigned to the queue. The available agents are listed in a numbered format, and the interface includes a search field and a selection list with checkboxes. The selection list shows four of eight agents selected, with checkmarks next to Guy Hawkins, Leslie Alexander, Wade Warren, and Savannah Nguyen. At the bottom of the panel, a Submit Selections button and a Cancel option are displayed, enabling the user to confirm or cancel the agent reassignment operation.

It should be appreciated that the selection interface enables the user to select multiple agents for reassignment in a single operation, thereby streamlining the process of adjusting queue staffing to address the identified anomaly. The search field allows the user to filter the agent list to locate specific agents within the list, which may be useful when the list of available agents is large. The checkbox selection mechanism enables the user to select a subset of the available agents based on operational considerations such as agent workload, skill proficiency, and scheduling constraints.

As further shown in FIG. 6D, the Copilot panel displays the completion of the agent reassignment workflow. In response to the selection of agents for reassignment, a success confirmation message with a checkmark icon states that four agents have been successfully reassigned. The confirmation message includes explanatory text indicating that the user should notice decreased waiting time on the queue as a result of the reassignment. The interface concludes with a prompt asking if there is anything else the assistant can help with, and an input field for asking additional questions.

By presenting available agents, enabling multi-select functionality, and confirming the reassignment operation, the context-aware assistant provides a guided workflow for adjusting queue staffing in response to operational anomalies. Throughout this workflow, the user remains on the same interface view, maintaining visibility of the operation progress while the system processes the agent reassignments and updates the queue configuration to address the identified performance issue.

The context-aware assistant is configured to utilize an AI model to analyze preconfigured case configurations and/or analyze a case definition at the time of configuration. The case configuration defines a plan and lifecycle of a case and one or more workitems, tasks, and/or interactions that may take place during handling of the case. The context-aware assistant is further configured to recommend suggestions for improving the case configuration to achieve a required business outcome.

Additionally, the context-aware assistant may use the AI model to analyze historical performance of cases and recommend or automatically implement configuration changes to deliver measurable performance improvements on future cases of the same type. It should be appreciated that, in addition to using historical performance to augment future performance, the context-aware assistant is configured to automatically detect other interactions or cases within the same organization that may be related to a given case, for the purposes of leveraging their context to accelerate the progress of that case.

The context-aware assistant may make improvement suggestions to the case configuration for achieving superior business outcomes (e.g., desired results, improved efficiency) that exceeds the required business outcomes. For example, if there were two outcome possibilities for a case, the context-aware assistant may configure a case, such that the more desired outcome is reached. In another example, the context-aware assistant may configure a case to achieve shorter completion time, better agent utilization, and/or better agent planning in work force management (WFM)/work engagement management (WEM), and/or shifts. Additionally, in some embodiments, the context-aware assistant is further configured to analyze operational data in a Personally Identifiable Information (PII)-sensitive manner to suggest changes to the existing configuration.

Additionally, in accordance with an embodiment of the present disclosure, the context-aware assistant is configured to automatically detect and create a case (also referred to as a work item) based on criteria of incoming or outgoing interactions between a contact center agent (or a virtual agent or a bot) and a customer. To do so, the context-aware assistant may integrate with a case management system. The generated case may be presented to the contact center agent in various ways, including within an AI-powered assistant (e.g., Genesys Agent Copilot). The context-aware assistant is configured to enable the AI-powered assistant to recommend and/or auto-generate a case on behalf of the contact center agent.

In accordance with an embodiment of the present disclosure, the context-aware assistant is configured to dynamically create a collaboration room (e.g., a swarm room, a group chat) with one or more required persons, groups, and/or virtual agents when a case is created. To do so, the context-aware assistant is configured to identify one or more required persons, groups, and/or virtual agents within the organization that can assist in accelerating the resolution of a case to meet a customer intent and deliver required business outcomes. In some embodiments, the context-aware assistant is further configured to use an AI model to identify or match any relevant resources (e.g., documents or links) and share the relevant resources in the collaboration room. As described above, the case may be created manually by a contact center agent or automatically by the context-aware assistant based on conversation.

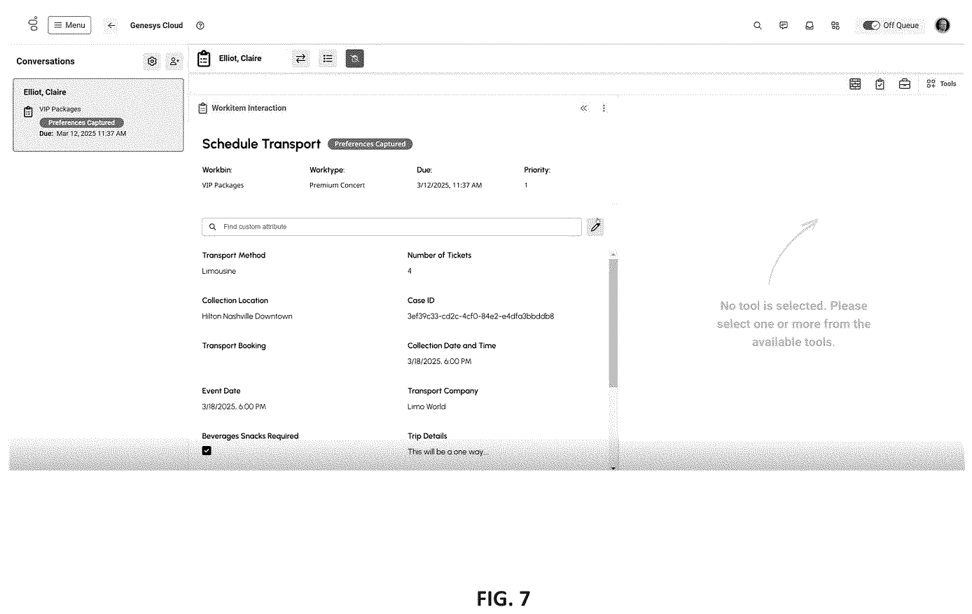

Turning now to FIGS. 7-15, exemplary partial screenshots of the graphical user interface (GUI) of a computing device are shown to illustrate features of a context-aware assistant of a computing system (e.g., the computing device 100, the contact center system 200, and/or other computing devices described herein). As described previously, the context-aware assistant supports automatic detection and creation of a case (also referred to as a work item) based on criteria of incoming or outgoing interactions between a contact center agent (or a virtual agent or a bot) and a customer. The generated case may be presented to the contact center agent in various ways, including within an AI-powered assistant. The context-aware assistant may integrate with a case management system to recommend and/or auto-generate a case on behalf of the contact center agent. For example, when a customer initiates an interaction requesting VIP concert services, the context-aware assistant may analyze the interaction content to identify the customer intent, such as requesting premium transportation arrangements for a concert event. Based on the identified customer intent and predefined criteria associated with the interaction type, the context-aware assistant may automatically detect that a case is required and may create the case without manual intervention by an agent or supervisor.

In the depicted example, a customer calls a contact center to purchase VIP packages for a premium concert, which includes premium seating, exclusive access, transportation, and hotel accommodations. Based on the conversation, a case is automatically created, tasks are automatically assigned to required agents of the contact center, and a group chat room is automatically created for the required agents to collaborate and share status updates. One of the required agents is a transport coordinator agent, who has been delivered a task of assigning a driver for the customer to provide the transportation. Exemplary screenshots shown in FIGS. 7-15 are the graphical user interface (GUI) of a computing device of the transport coordinator agent.

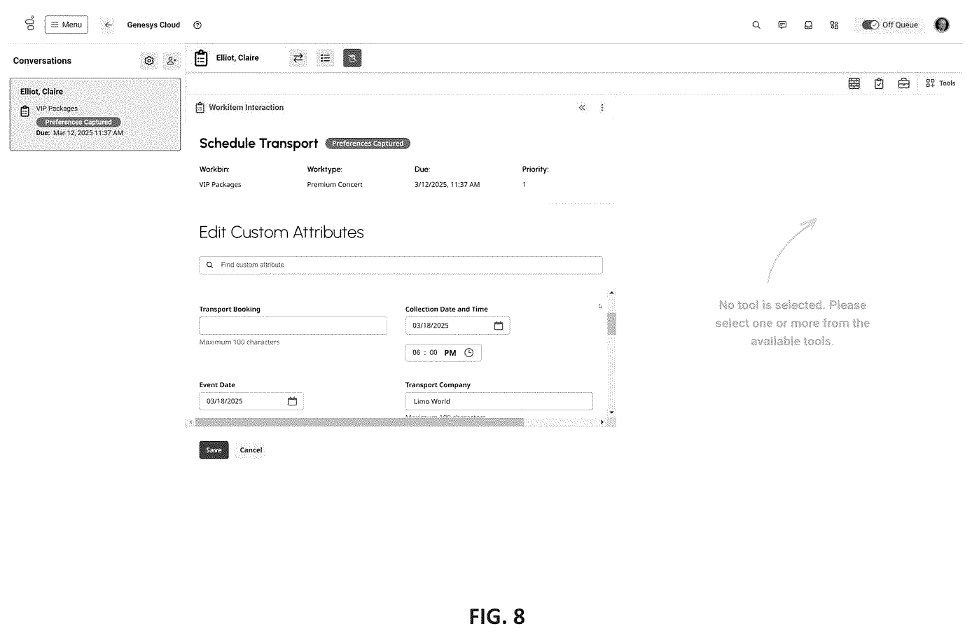

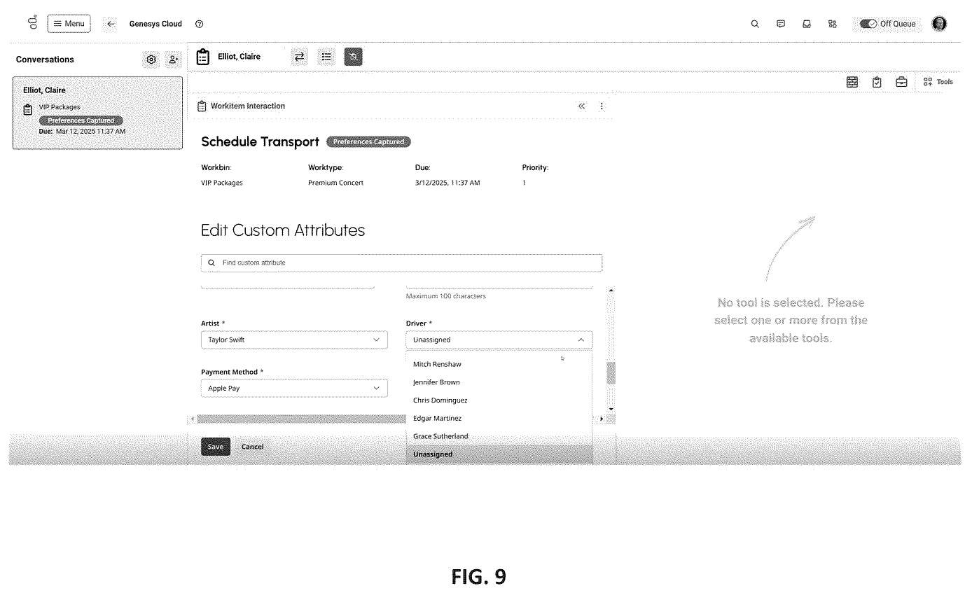

More specifically, as shown in FIG. 7, a task is delivered to a transport coordinator agent for assigning a driver for the customer as part of Schedule Transport workitem. The transport coordinator agent can then edit custom attributes and select/assign a driver, as shown in FIGS. 8 and 9. It should be appreciated that the custom attributes are a custom presentation for the thing to be done on the case based on the task the respective agent is working on. Once the driver is assigned, the transport coordinator agent can select “Cases” toggle button to display the Cases tool on a panel next to the Schedule Transport Workitem panel. It should be appreciated that multiple tools may be displayed in their respective panel, the size of which may be adjusted based on the number of selected tools. However, the main Schedule Transport Workitem panel will remain displayed on the main panel unaffected.

As described previously, managing work items includes creating, assigning, tracking, and updating one or more tasks associated with user interactions or operational workflows based on the requested operation. The workitem interaction view depicted in FIG. 7 illustrates how work items are tracked within the contact center platform. The workitem displays attributes that define the task to be performed, including transport details, scheduling information, and custom fields that capture operational requirements. The status indicator showing Preferences Captured indicates the current stage of the work item within the operational workflow, enabling supervisors and agents to track progress through the task lifecycle.

Additionally, the custom attribute editing interface depicted in FIG. 8 demonstrates how work items are updated within the contact center platform. The Edit Custom Attributes section enables users to modify work item attributes to reflect current operational information. The Transport Booking field enables entry of booking reference information, while the Collection Date and Time field enables scheduling of transport services. The Event Date field captures the date of the associated event, and the Transport Company field identifies the service provider assigned to fulfill the transport request. The Save and Cancel buttons enable the user to persist changes to the work item or discard modifications without affecting the stored work item data.

As further shown in FIG. 8, the custom attribute editing functionality supports updating tasks associated with operational workflows. When the agent modifies custom attributes and selects the Save button, the system updates the work item with the revised attribute values. The updated work item reflects the current state of the task, enabling other users and systems within the contact center platform to access accurate information about the work item status and associated details

Moreover, the driver assignment interface depicted in FIG. 9 demonstrates how work items are assigned within the contact center platform. The Driver field dropdown menu presents available drivers who may be assigned to fulfill the transport task. The assignment operation enables supervisors or agents to associate a specific resource with the work item, thereby assigning responsibility for task completion. When a driver is selected from the dropdown menu and the Save button is activated, the system updates the work item to reflect the driver assignment, enabling tracking of the assigned resource throughout the task lifecycle.

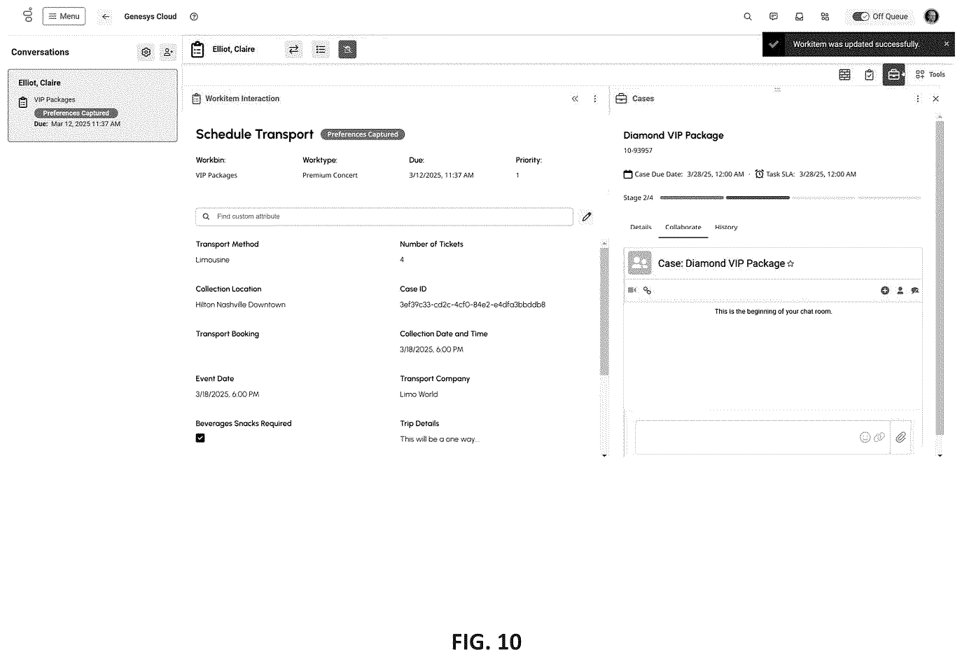

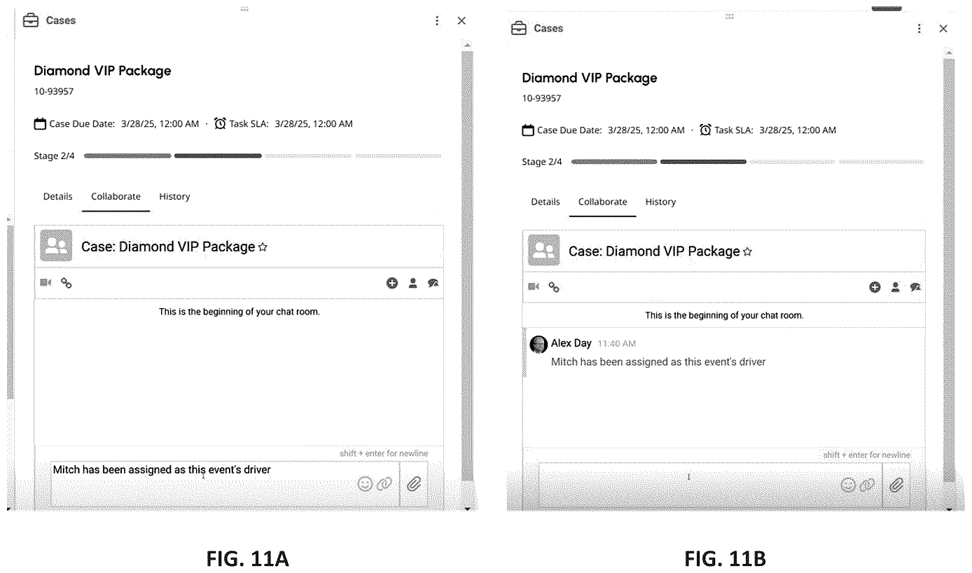

As shown in FIG. 10, the transport coordinator agent may select “Collaborate” tab to access a group chat for “Case: Diamond VIP Package.” The chat room section within the cases panel demonstrates dynamic creation of a collaboration room associated with the case. The context-aware assistant may dynamically create a collaboration room with persons, groups, or virtual agents within the organization that may assist in accelerating case resolution. The collaboration room, also referred to as a swarm room or group chat, enables multiple participants to communicate and coordinate activities related to the case. The context-aware assistant may determine who should be invited to the collaboration room based on the case and determined subtasks associated with the case. In the depicted example, the transport coordinator agent can notify other members of the group chat that “Mitch has been assigned as this event's driver,” as shown in FIGS. 11A and 11B. In other words, the collaboration room provides a communication channel through which participants may share updates, coordinate activities, and exchange information relevant to case resolution. The collaboration room maintains a history of messages exchanged among participants, enabling team members to review prior communications and understand the current state of case activities.

The system may automatically determine subtasks to resolve the case and may determine who should be invited to the collaboration room based on the case and the subtasks. For example, when a case involves multiple stages such as capturing preferences, arranging customer transportation, performing background checks, and scheduling VIP backstage arrangements, the system may analyze each stage and the associated subtasks to identify participants who may contribute to completing the subtasks. The AI model may evaluate participant attributes such as skills, roles, availability, and historical performance to identify or match resources to add to the collaboration room. The identified resources may include agents, supervisors, specialists, or virtual agents that may assist in accelerating case resolution by contributing expertise or performing automated tasks associated with the case workflow.

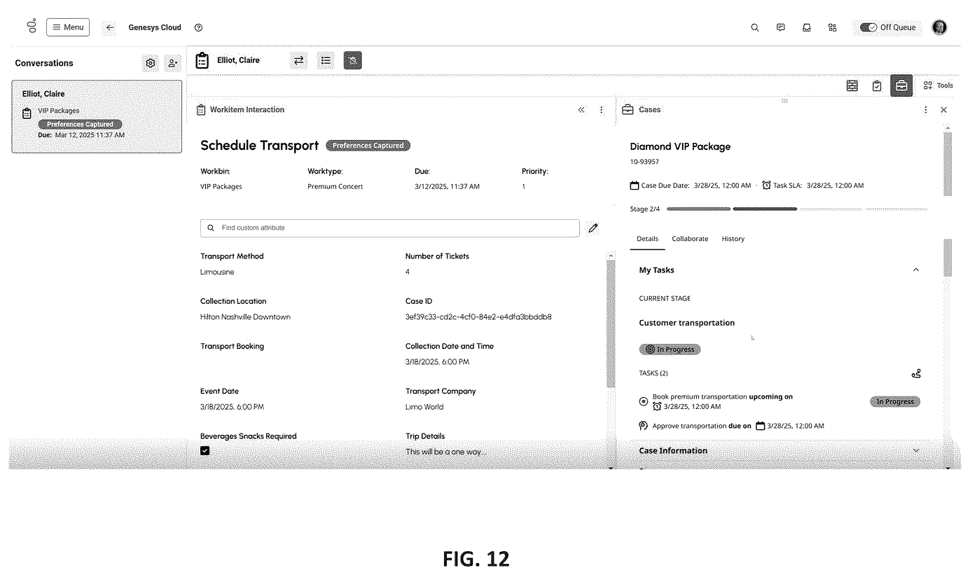

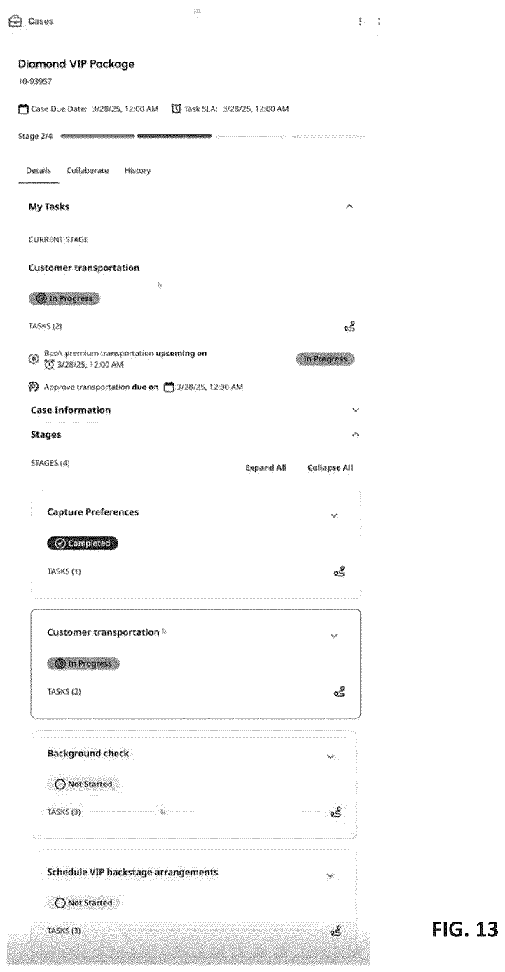

As shown in FIGS. 12 and 13, the transport coordinator agent can also view the details of the assigned case. For example, the transport coordinator agent can view stages of all of the other tasks that are being accomplished in parallel to ensure that the required business outcomes are being met.

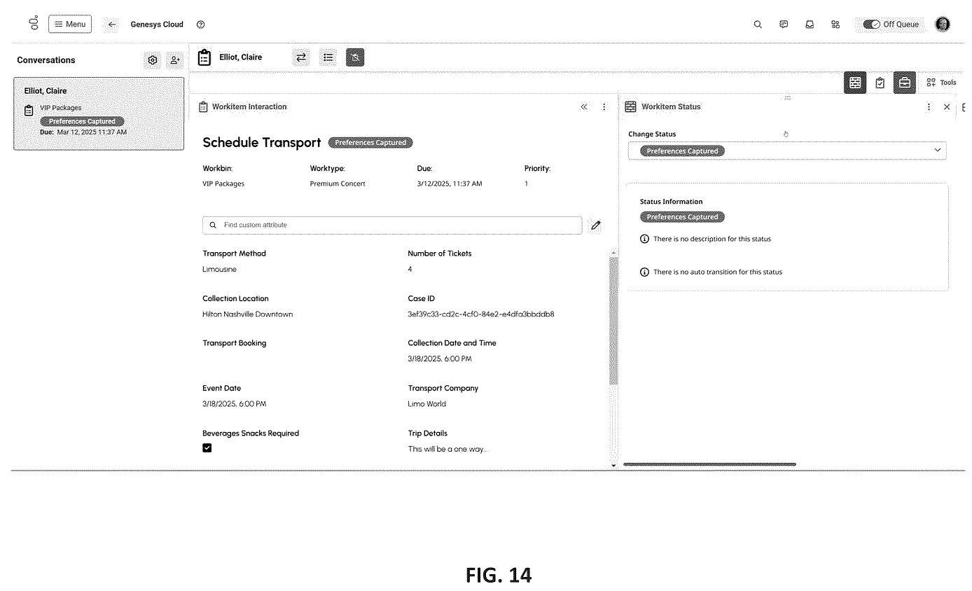

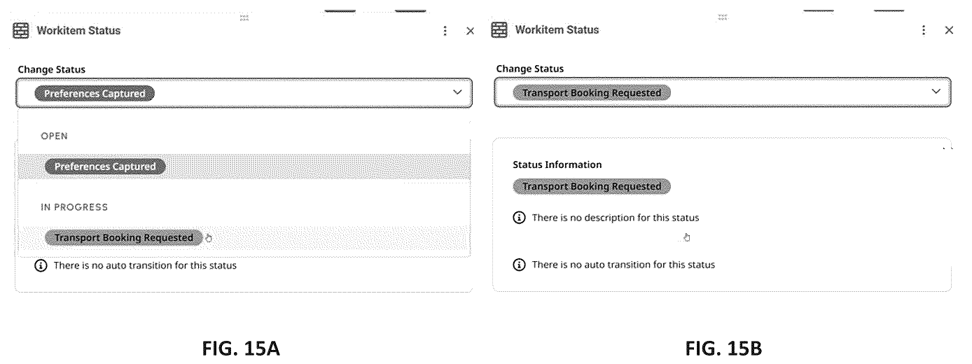

Finally, as shown in FIGS. 14 and 15, the transport coordinator agent can select “Workitem Status” toggle button to display the Workitem Status tool, where the transport coordinator agent can update the status of the task from “Preferences Captured” to “Transport Booking Requested” to show the completion of the task assigned to the transport coordinator agent.

As further shown in FIG. 15A, the status selection interface demonstrates how users update task status within the case lifecycle. The dropdown menu organizes available statuses into categories such as OPEN and IN PROGRESS, enabling users to identify the appropriate status based on the current state of the work item. When a user selects a status from the dropdown menu, the system updates the Change Status field to reflect the selected status and displays the associated status information. The status transition from Preferences Captured to Transport Booking Requested represents progression of the work item through the defined workflow stages, indicating that the task has advanced from an initial open state to an in-progress state where transport booking has been requested.

It should be appreciated that, although three toggle buttons are shown in the tool bar shown in FIGS. 7-15, the context-aware assistant is configured to customize the tool bar for each required person or group based on the assigned task by determining and providing tools that support specific actions associated with the assigned task. In other words, agent experience is customized for what the respective agent is working on, thereby making the agent experience more streamlined.

In accordance with at least one example of the present disclosure, a method for providing context-aware assistance in a contact center platform is provided. The method includes determining user context data associated with a user of a contact center, the user context data including a current application context. The method further includes receiving a user input from the user on an interface view indicative of a requested operation, the requested operation including at least one of: retrieving information, managing one or more users, or managing work items. The method also includes determining operational context data, the operational context data being contextually relevant information associated with the requested operation based on a role of the user and the current application context. The method additionally includes determining if the user is authorized to perform the requested operation based on the role of the user. The method further includes, in response to determining that the user is authorized, performing the requested operation based on the operational context data without navigating away from the interface view.

In accordance with at least one aspect of the above method, the method may include where the user context data includes a role of the user within a contact center, the current application context based on user interaction data within the contact center platform, metadata associated with those interactions, historical usage patterns, and/or the present operational context of the contact center.

In accordance with at least one aspect of the above method, the method may include where wherein determining the user context data associated with the user comprises receiving user interaction data of the user indicating navigation within a graphical user interface (GUI) of the contact center platform and determining the current application context based on the user interaction data.

In accordance with at least one aspect of the above method, the method may include where the user interaction data includes at least one of: an active portion of the GUI that is currently visible to the user; a workflow state which describes a current step or stage within a predefined process or task flow that the user is engaged in; or a user navigation path within the graphical user interface.

In accordance with at least one aspect of the above method, the method may further include in response to determining that the user is not authorized to perform the requested operation, determining an authorized person who is authorized to perform the requested operation, and generating a work item to create a task for the authorized person to approve the user to perform the requested operation.

In accordance with at least one aspect of the above method, the method may include where performing the requested operation based on the operational context data without navigating away from the interface view comprises in response to determining that the user is authorized, determining whether additional information is required to complete the requested operation based on the user context data, in response to determining that additional information is required, generating a clarification query requesting the additional information from the user, receiving the additional information from the user, processing the requested operation with the additional information to generate a response corresponding to completion of the requested operation, and providing the response to the user via the interface view.

In accordance with at least one aspect of the above method, the method may include where the user input includes a selection of a supervisory resource from a plurality of supervisory resources, and wherein the plurality of supervisory resources includes at least one of: interaction summaries, user management, evaluation forms, performance insights, or coaching recommendations.

In accordance with at least one aspect of the above method, the method may include where the retrieving information includes accessing one or more knowledge bases associated with an organization of the user and filtering the retrieved information based on the current application context, wherein the accessing is subject to permission constraints associated with the role of the user.

In accordance with at least one aspect of the above method, the method may include where managing one or more users includes at least one of: adding new users, managing attributes for users to ensure routing behavior and user skill profiles align with operational needs, assigning or removing users from queues to control how interactions are distributed and ensure staffing aligns with demand, assigning or revoking user roles to control access to features and enforce proper authorization boundaries across an organization, or assigning or updating user phone configurations or station settings to ensure compatibility with telephony and voice interaction workflows.

In accordance with at least one aspect of the above method, the method may include where managing work items includes creating, assigning, tracking, and updating one or more tasks associated with user interactions or operational workflows based on the requested operation.

In accordance with at least one aspect of the above method, the method may include where the user input is expressed in natural language, and wherein the method further comprises processing the user input to determine an intent associated with the requested operation.

In accordance with at least one aspect of the above method, the method may further include prior to receiving the user input, automatically generating a work item for the user based on the user context data.

In accordance with at least one aspect of the above method, the method may include where automatically generating the work item for the user based on the user context data comprises detecting a performance anomaly based on the user context data associated with the user, wherein the performance anomaly includes an unusual behavior in one or more system metrics associated with the contact center platform, in response to detecting the performance anomaly and prior to receiving the user input, automatically creating a work item for the user, wherein the work item is one or more tasks to be performed in response to the anomaly detection, and providing a notification to the user that the work item has been created.

According to another aspect of the present disclosure, a system for providing context-aware assistance in a contact center platform is provided. The system includes a processor and a memory storing instructions that, when executed by the processor, cause the system to determine user context data associated with a user of a contact center, the user context data including a current application context. The instructions further cause the system to receive a user input from the user on an interface view indicative of a requested operation, the requested operation including at least one of: retrieving information, managing one or more users, or managing work items. The instructions also cause the system to determine operational context data, the operational context data being contextually relevant information associated with the requested operation based on a role of the user and the current application context. The instructions additionally cause the system to determine if the user is authorized to perform the requested operation based on the role of the user. The instructions further cause the system to, in response to the determination that the user is authorized, perform the requested operation based on the operational context data without navigating away from the interface view.

In accordance with at least one aspect of the above system, the system may include where to determine the user context data associated with the user comprises to receive user interaction data of the user indicating navigation within a graphical user interface (GUI) of the contact center platform, and to determine the current application context based on the user interaction data, wherein the user interaction data includes at least one of: an active portion of the GUI that is currently visible to the user; a workflow state which describes a current step or stage within a predefined process or task flow that the user is engaged in; or a user navigation path within the GUI.

In accordance with at least one aspect of the above system, the instructions may further cause the system to in response to the determination that the user is not authorized to perform the requested operation, determine an authorized person who is authorized to perform the requested operation, and generate a work item to create a task for the authorized person to approve the user to perform the requested operation.

In accordance with at least one aspect of the above system, the system may include where to perform the requested operation based on the operational context data without navigating away from the interface view comprises to in response to the determination that the user is authorized, to determine whether additional information is required to complete the requested operation based on the user context data, in response to the determination that additional information is required, to generate a clarification query requesting the additional information from the user, to receive the additional information from the user, to process the requested operation with the additional information to generate a response corresponding to completion of the requested operation, and to provide the response to the user via the interface view.

In accordance with at least one aspect of the above system, the instructions may further cause the system to prior to the receipt of the user input, automatically generate a work item for the user based on the user context data, wherein to automatically generate the work item for the user based on the user context data comprises to detect a performance anomaly based on the user context data associated with the user, wherein the performance anomaly includes an unusual behavior in one or more system metrics associated with the contact center platform, in response to the detection of the performance anomaly and prior to the receipt of the user input, automatically create the work item for the user, wherein the work item is one or more tasks to be performed in response to the anomaly detection, and provide a notification to the user that the work item has been created.

According to yet another aspect of the present disclosure, a non-transitory computer-readable medium storing instructions that, when executed by a processor, cause the processor to perform operations is provided. The operations include determining user context data associated with a user of a contact center, the user context data including a current application context. The operations further include receiving a user input from the user on an interface view indicative of a requested operation, the requested operation including at least one of: retrieving information, managing one or more users, or managing work items. The operations also include determining operational context data, the operational context data being contextually relevant information associated with the requested operation based on a role of the user and the current application context. The operations additionally include determining if the user is authorized to perform the requested operation based on the role of the user. The operations further include, in response to determining that the user is authorized, performing the requested operation based on the operational context data without navigating away from the interface view

In accordance with at least one aspect of the above non-transitory computer-readable medium, the operations may further include prior to receiving the user input, automatically generating a work item for the user based on the user context data, wherein the automatically generating the work item for the user based on the user context data comprises, detecting a performance anomaly based on the user context data associated with the user, wherein the performance anomaly includes an unusual behavior in one or more system metrics associated with the contact center platform, in response to detecting the performance anomaly and prior to receiving the user input, automatically creating a work item for the user, wherein the work item is one or more tasks to be performed in response to the anomaly detection, and providing a notification to the user that the work item has been created.

As one of skill in the art will appreciate, the many varying features and configurations described above in relation to the several exemplary embodiments may be further selectively applied to form the other possible embodiments of the present disclosure. For the sake of brevity and taking into account the abilities of one of ordinary skill in the art, each of the possible iterations is not provided or discussed in detail, though all combinations and possible embodiments embraced by the several claims below or otherwise are intended to be part of the instant application. Further, it should be apparent that the foregoing relates only to the described embodiments of the present application and that numerous changes and modifications may be made herein without departing from the spirit and scope of the present application as defined by the following claims and the equivalents thereof.

Although the concepts of the present disclosure are susceptible to various modifications and alternative forms, specific embodiments have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. It should be further appreciated that although reference to a “preferred” component or feature may indicate the desirability of a particular component or feature with respect to an embodiment, the disclosure is not so limiting with respect to other embodiments, which may omit such a component or feature. Further, when a particular feature, structure, or characteristic is described in connection with an embodiment, it is submitted that it is within the knowledge of one skilled in the art to implement such feature, structure, or characteristic in connection with other embodiments whether or not explicitly described. Further, particular features, structures, or characteristics may be combined in any suitable combinations and/or sub-combinations in various embodiments.

As used herein, the term “AI model” (or “artificial intelligence model”) refers to a computational model that is trained to perform tasks by learning patterns from data. An AI model may include, but is not limited to, machine learning models, deep learning models, neural networks, large language models (LLMs), natural language processing models, or other models that utilize statistical or algorithmic techniques to process inputs and generate outputs. An AI model may be trained using supervised learning, unsupervised learning, reinforcement learning, or other training methodologies. In some cases, an AI model may be implemented using cloud-based AI infrastructure or may be deployed locally within a computing environment.

As used herein, the terms “virtual agent” and “AI agent” may be used interchangeably and refer to a software-based entity that is configured to perform tasks, make decisions, or interact with users autonomously or semi-autonomously using artificial intelligence techniques. A virtual agent or AI agent may utilize one or more AI models to process inputs, understand context, and generate responses or actions. In some cases, a virtual agent or AI agent may be configured to handle customer interactions within a contact center environment, such as responding to customer inquiries, routing interactions, or performing automated tasks on behalf of human agents. A virtual agent or AI agent may also be referred to as a bot, chatbot, conversational agent, or intelligent assistant.

As used herein, the terms “case” and “work item” may be used interchangeably and refer to a unit of work that is created, tracked, and managed within a contact center platform or workflow management system. A case or work item may represent a customer request, an operational task, or a collection of related tasks that are to be completed to achieve a desired outcome. A case or work item may include one or more subtasks, may be associated with one or more stages or workflow states, and may have attributes such as priority, due date, status, and assigned owner. In some cases, a case or work item may be automatically created based on customer interactions, detected anomalies, or predefined criteria, and may be assigned to agents, supervisors, or AI agents for resolution.

Additionally, it should be appreciated that items included in a list in the form of “at least one of A, B, and C” can mean (A); (B); (C); (A and B); (B and C); (A and C); or (A, B, and C). Similarly, items listed in the form of “at least one of A, B, or C” can mean (A); (B); (C); (A and B); (B and C); (A and C); or (A, B, and C). Further, with respect to the claims, the use of words and phrases such as “a,” “an,” “at least one,” and/or “at least one portion” should not be interpreted so as to be limiting to only one such element unless specifically stated to the contrary, and the use of phrases such as “at least a portion” and/or “a portion” should be interpreted as encompassing both embodiments including only a portion of such element and embodiments including the entirety of such element unless specifically stated to the contrary.

The disclosed embodiments may, in some cases, be implemented in hardware, firmware, software, or a combination thereof. The disclosed embodiments may also be implemented as instructions carried by or stored on one or more transitory or non-transitory machine-readable (e.g., computer-readable) storage media, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures unless indicated to the contrary. Additionally, the inclusion of a structural or method feature in a particular figure is not meant to imply that such feature is required in all embodiments and, in some embodiments, may not be included or may be combined with other features.

That which is claimed:

1. A method for providing context-aware assistance in a contact center platform, the method comprising:
determining user context data associated with a user of a contact center, the user context data including a current application context;
receiving a user input from the user on an interface view indicative of a requested operation, the requested operation including at least one of: retrieving information, managing one or more users, or managing work items;
determining operational context data, the operational context data being contextually relevant information associated with the requested operation based on a role of the user and the current application context;
determining if the user is authorized to perform the requested operation based on the role of the user; and
in response to determining that the user is authorized, performing the requested operation based on the operational context data without navigating away from the interface view.

2. The method of claim 1, wherein the user context data includes a role of the user within a contact center, the current application context based on user interaction data within the contact center platform, metadata associated with those interactions, historical usage patterns, and/or the present operational context of the contact center.

3. The method of claim 1, wherein determining the user context data associated with the user comprises:
receiving user interaction data of the user indicating navigation within a graphical user interface (GUI) of the contact center platform; and
determining the current application context based on the user interaction data.

4. The method of claim 3, wherein the user interaction data includes at least one of: an active portion of the GUI that is currently visible to the user; a workflow state which describes a current step or stage within a predefined process or task flow that the user is engaged in; or a user navigation path within the graphical user interface.

5. The method of claim 1, further comprising:
in response to determining that the user is not authorized to perform the requested operation, determining an authorized person who is authorized to perform the requested operation; and
generating a work item to create a task for the authorized person to approve the user to perform the requested operation.

6. The method of claim 1, wherein performing the requested operation based on the operational context data without navigating away from the interface view comprises:
in response to determining that the user is authorized, determining whether additional information is required to complete the requested operation based on the user context data;
in response to determining that additional information is required, generating a clarification query requesting the additional information from the user;
receiving the additional information from the user;
processing the requested operation with the additional information to generate a response corresponding to completion of the requested operation; and
providing the response to the user via the interface view.

7. The method of claim 1, wherein the user input includes a selection of a supervisory resource from a plurality of supervisory resources, and wherein the plurality of supervisory resources includes at least one of: interaction summaries, user management, evaluation forms, performance insights, or coaching recommendations.

8. The method of claim 1, wherein the retrieving information includes accessing one or more knowledge bases associated with an organization of the user and filtering the retrieved information based on the current application context, wherein the accessing is subject to permission constraints associated with the role of the user.

9. The method of claim 1, wherein managing one or more users includes at least one of: adding new users, managing attributes for users to ensure routing behavior and user skill profiles align with operational needs, assigning or removing users from queues to control how interactions are distributed and ensure staffing aligns with demand, assigning or revoking user roles to control access to features and enforce proper authorization boundaries across an organization, or assigning or updating user phone configurations or station settings to ensure compatibility with telephony and voice interaction workflows.

10. The method of claim 1, wherein managing work items includes creating, assigning, tracking, and updating one or more tasks associated with user interactions or operational workflows based on the requested operation.

11. The method of claim 1, wherein the user input is expressed in natural language, and wherein the method further comprises processing the user input to determine an intent associated with the requested operation.

12. The method of claim 1, further comprising:
prior to receiving the user input, automatically generating a work item for the user based on the user context data.

13. The method of claim 12, wherein automatically generating the work item for the user based on the user context data comprises:
detecting a performance anomaly based on the user context data associated with the user, wherein the performance anomaly includes an unusual behavior in one or more system metrics associated with the contact center platform;
in response to detecting the performance anomaly and prior to receiving the user input, automatically creating a work item for the user, wherein the work item is one or more tasks to be performed in response to the anomaly detection; and
providing a notification to the user that the work item has been created.

14. A system for providing context-aware assistance in a contact center platform, the system comprising:
a processor; and
a memory storing instructions that, when executed by the processor, cause the system to:
determine user context data associated with a user of a contact center, the user context data including a current application context;
receive a user input from the user on an interface view indicative of a requested operation, the requested operation including at least one of: retrieving information, managing one or more users, or managing work items;
determine operational context data, the operational context data being contextually relevant information associated with the requested operation based on a role of the user and the current application context;
determine if the user is authorized to perform the requested operation based on the role of the user; and
in response to the determination that the user is authorized, perform the requested operation based on the operational context data without navigating away from the interface view.

15. The system of claim 14, wherein to determine the user context data associated with the user comprises to:
receive user interaction data of the user indicating navigation within a graphical user interface (GUI) of the contact center platform; and
determine the current application context based on the user interaction data,
wherein the user interaction data includes at least one of: an active portion of the GUI that is currently visible to the user; a workflow state which describes a current step or stage within a predefined process or task flow that the user is engaged in; or a user navigation path within the GUI.

16. The system of claim 14, wherein the instructions further cause the system to:
in response to the determination that the user is not authorized to perform the requested operation, determine an authorized person who is authorized to perform the requested operation; and
generate a work item to create a task for the authorized person to approve the user to perform the requested operation.

17. The system of claim 14, wherein to perform the requested operation based on the operational context data without navigating away from the interface view comprises to:
in response to the determination that the user is authorized, determine whether additional information is required to complete the requested operation based on the user context data;
in response to the determination that additional information is required, generate a clarification query requesting the additional information from the user;
receive the additional information from the user;
process the requested operation with the additional information to generate a response corresponding to completion of the requested operation; and
provide the response to the user via the interface view.

18. The system of claim 14, wherein the instructions further cause the system to:
prior to the receipt of the user input, automatically generate a work item for the user based on the user context data, wherein to automatically generate the work item for the user based on the user context data comprises to:
detect a performance anomaly based on the user context data associated with the user, wherein the performance anomaly includes an unusual behavior in one or more system metrics associated with the contact center platform;
in response to the detection of the performance anomaly and prior to the receipt of the user input, automatically create the work item for the user, wherein the work item is one or more tasks to be performed in response to the anomaly detection; and
provide a notification to the user that the work item has been created.

19. A non-transitory computer-readable medium storing instructions that, when executed by a processor, cause the processor to perform operations comprising:
determining user context data associated with a user of a contact center, the user context data including a current application context;
receiving a user input from the user on an interface view indicative of a requested operation, the requested operation including at least one of: retrieving information, managing one or more users, or managing work items;
determining operational context data, the operational context data being contextually relevant information associated with the requested operation based on a role of the user and the current application context;
determining if the user is authorized to perform the requested operation based on the role of the user; and
in response to determining that the user is authorized, performing the requested operation based on the operational context data without navigating away from the interface view.

20. The non-transitory computer-readable medium of claim 19, wherein the operations further comprise:
prior to receiving the user input, automatically generating a work item for the user based on the user context data, wherein the automatically generating the work item for the user based on the user context data comprises:
detecting a performance anomaly based on the user context data associated with the user, wherein the performance anomaly includes an unusual behavior in one or more system metrics associated with the contact center platform;
in response to detecting the performance anomaly and prior to receiving the user input, automatically creating a work item for the user, wherein the work item is one or more tasks to be performed in response to the anomaly detection; and
providing a notification to the user that the work item has been created.
